(19) United States
(12) Patent Application Publication
(10) Pub. No.: US 2024/0354360 A1
(43) Pub. Date: Oct. 24, 2024

(54) METHOD AND APPARATUS FOR SOLVING SYSTEM OF NONLINEAR EQUATIONS BASED ON QUANTUM CIRCUIT, AND STORAGE MEDIUM

(71) Applicant: ORIGIN QUANTUM COMPUTING TECHNOLOGY (HEFEI) CO., LTD, Anhui (CN)

(72) Inventors: YE LI, Anhui (CN); MENGHAN DOU, Anhui (CN); NINGBO AN, Anhui (CN)

(21) Appl. No.: 18/294,765

(22) PCT Filed: Nov. 25, 2022
(86) PCT No.: PCT/CN2022/134387

§ 371 Date: Feb. 2, 2024

(30) Foreign Application Priority Data
Nov. 26, 2021 (CN) 202111421916.0
Nov. 26, 2021 (CN) 202111425744.4
Dec. 3, 2021 (CN) 202111470416.6
Dec. 14, 2021 (CN) 202111527379.8

(51) Int. Cl. G06F 17/11; G06F 17/16; G06N 10/20

(52) U.S. Cl. CPC G06F 17/11; G06F 17/16; G06N 10/20

(57) ABSTRACT

A method for solving a system of nonlinear equations on the basis of a quantum circuit includes acquiring a target system of nonlinear equations to be solved, converting the target system to obtain a target system of linear equations, constructing a quantum circuit corresponding to a quantum linear solver used for solving the target system, performing, based on the quantum circuit corresponding to the quantum linear solver, quantum state evolution and measurement on the target system, to solve the target system, and determining, based on an obtained solution of the target system, a solution of the target system to be solved. With the method, the complexity and difficulty in solving a system of nonlinear equations may be reduced, thereby filling in related technical gaps in the field of quantum computation.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/CN2022/134387, filed Nov. 25, 2022, which claims priority to the benefit of Chinese Patent Application Nos. 202111421916.0 filed on Nov. 26, 2021, 202111425744.4 filed on Nov. 26, 2021, 202111470416.6 filed on Dec. 3, 2021 and 202111527379.8 filed on Dec. 14, 2021 in the China Intellectual Property Office, the entire contents of which are incorporated herein by reference.

### BACKGROUND

### 1. Technical Field

The present disclosure generally relates to the technical field of quantum computation. More specifically, the present disclosure relates to a method, an apparatus, a storage medium and an electronic device for solving a system of nonlinear equations based on a quantum circuit.

### 2. Background Art

The study of nonlinear equations for the purpose of application, or with the background of physics, mechanics or other subject issues, is not only one of the most important contents in traditional applied mathematics, but also an important part of contemporary mathematics, as well as an important bridge between mathematical theories and practical applications.

On the other hand, nonlinear problems are more common in nature, such as nonlinear finite element analysis, nonlinear dynamics, nonlinear programming, and the like. Therefore, it is important to construct a quantum algorithm for solving nonlinear problems. However, due to the linearity of quantum computation itself, there will be difficulties in constructing the quantum algorithm for solving nonlinear problems, and the study on quantum algorithms for solving a system of nonlinear equations is still relatively scarce.

At present, many significant problems in natural science and engineering technology can be attributed to the study of nonlinear equations. Mathematical models in many fields of real life can be described by nonlinear equations, but in general, it is difficult to obtain efficient solutions of systems of nonlinear equations easily with traditional numerical methods. Therefore, the study on how to accurately and quickly solve a system of nonlinear equations has shown very important theoretical and application values. The quantum computation is a novel computation method, the principle of which is to construct a computing framework based on the theory of quantum mechanics. When solving some problems, quantum computation has an exponential speed-up effect compared with the optimal classical algorithm.

Existing methods for solving a system of nonlinear equations typically consume a lot of computing resources, which may beyond the computing power of traditional computers, and involve a higher computation complexity, a longer time to obtain an accurate solution and more difficult computation. In this context, it is important to develop a more efficient algorithm for solving a system of nonlinear equations.

### SUMMARY

In order to solve at least one or more technical problems described in the background section, the present disclosure proposes a method and an apparatus for solving a system of nonlinear ordinary differential equations on the basis of a quantum circuit to address deficiencies in the existing art, which can implement the technology of solving a system of nonlinear ordinary differential equations with a quantum algorithm, and reduce the complexity and difficulty in solving a system of nonlinear ordinary differential equations, thereby filling in related technical gaps in the field of quantum computation. In view of this, the present disclosure provides solutions in the following aspects.

In a first aspect, the present disclosure provides a method for solving a system of nonlinear ordinary differential equations on the basis of a quantum circuit, including: acquiring information about a system of nonlinear ordinary differential equations to be processed; converting the system of nonlinear ordinary differential equations to be processed to obtain a target system of linear ordinary differential equations; constructing a quantum circuit corresponding to a quantum linear solution algorithm, and performing quantum state evolution and measurement on the target system of linear ordinary differential equations, to acquire a solution of the target system of linear ordinary differential equations; calculating, according to the solution of the target system of linear ordinary differential equations, a solution of the system of nonlinear ordinary differential equations to be processed.

In one embodiment, the system of nonlinear ordinary differential equations to be processed is:

$$\frac{du}{dt} = {F}_{1} u + {F}_{2} {u}^{⊗ 2} , u ( 0 ) = {u}_{in}$$

where u is a function to be solved of the system of nonlinear ordinary differential equations to be processed, u∈ [symbol] ⁿ, [symbol] is real number space, and F₁ and F₂ are sparse matrices independent of time with a sparsity s, F₁∈ [symbol] ^{n×n}, and F₂∈ [symbol] ^{n×n}^{²}.

In one embodiment, converting the system of nonlinear ordinary differential equations to be processed to obtain the target system of linear ordinary differential equations includes: converting the system of nonlinear ordinary differential equations to be processed into a preset type of system of nonlinear ordinary differential equations in a homotopy perturbation method; and converting the preset type of system of nonlinear ordinary differential equations into the target system of linear ordinary differential equations in a linear embedding method.

In one embodiment, the preset type of system of nonlinear ordinary differential equations is:

$$\frac{{dv}_{0}}{dt} - {F}_{1} {v}_{0} = 0 , {v}_{0} ( 0 ) = {u}_{in}$$

$$\frac{{dv}_{1}}{dt} - {F}_{1} {v}_{1} - {F}_{2} {v}_{0} ⊗ {v}_{0} = 0 , {v}_{1} ( 0 ) = 0$$

$$\frac{{dv}_{2}}{dt} - {F}_{1} {v}_{2} - {F}_{2} ( {v}_{0} ⊗ {v}_{1} + {v}_{1} ⊗ {v}_{0} ) = 0 , {v}_{2} ( 0 ) = 0$$

$$…$$

$$\frac{{dv}_{c}}{dt} - {F}_{1} {v}_{c} - {F}_{2} {\sum }_{j = 0}^{c - 1} {v}_{j} ⊗ {v}_{c - 1 - j} = 0 , {v}_{c} ( 0 ) = 0$$

where the c is the number of functions to be solved in the preset type of system of nonlinear ordinary differential equations to be processed, vᵢ is a function to be solved of the preset type of system of nonlinear ordinary differential equations be processed, and 0≤i≤c.

In one embodiment, the target system of linear ordinary differential equations is:

$$\frac{d \vec{y}}{dt} = A \vec{y} , \vec{y} ( 0 ) = {y}_{in}$$

where [symbol] =[\vec{y}₀, \vec{y}₁, \vec{y}₂, . . . , \vec{y}_{c}], \vec{y}ⱼ satisfies:

$${\vec{y}}_{i} = \{ \begin{matrix}[ {v}_{0} + {v}_{1} + {v}_{2} + … + {v}_{c} ] , i = 0 \\ [ {\vec{y}}_{i , 0} , {\vec{y}}_{i , 1} , {\vec{y}}_{i , 2} , … , {\vec{y}}_{i , {β}_{i} - 1} ] , 1 \leq i \leq c\end{matrix}$$

yᵢₙ=[[uᵢₙ], [uᵢₙ^{⊗}^{²}, 0, . . . , 0] [uᵢₙ^{⊗}^{³}, 0 . . . , 0] [uᵢₙ^{⊗}^{^{c}}]], Bᵢ represents the number of items in \vec{y}ⱼ, and

$${β}_{i} = \{ \begin{matrix}1 , i = 0 \\ {\sum }_{k = i}^{c} ( \begin{matrix}k \\ i\end{matrix} ) , 1 \leq i \leq c\end{matrix} , {\vec{y}}_{i , j}$$

represents a j^{th} item in \vec{y}ᵢ, expressed as \vec{y}_{i,j}=⊗ₖ₌₀ⁱvₐ_{_{i,j,k}}, and a_{i,j,k} satisfies a_{i,j,k}≥0, i+1≤Σₖ₌₀ⁱa_{i,j,k}+1≤c+1.

In one embodiment, constructing the quantum circuit corresponding to the quantum linear solution algorithm includes:

constructing a quantum circuit that implements a first functional module V, where the first functional module is defined as

$$V \vert {0}^{m} 〉 := \frac{1}{\sqrt{α}} {\sum }_{i} \sqrt{{α}_{i}} \vert i 〉 , α = 4 {\sum }_{j = 0}^{{j}_{0}} {( - 1 )}^{j} \frac{{\sum }_{i = j + 1}^{b} ( \begin{matrix}2 b \\ b + j\end{matrix} )}{{2}^{2 b}} ,$$

$${j}_{0} = \sqrt{blog ( 4 b / ϵ )} , b = {κ}^{2} log ( κ / ϵ ) ;$$

constructing a quantum circuit that implements a second functional module combination, where the quantum circuit for the second functional module combination includes T, W and T⁺, the T=Σ_{j∈[N]}|Ψⱼ [symbol] j|, W=S·(2T·T⁺−I_{4N}_{²}), the S is a unitary matrix of an exchange operation module, the T⁺ is a transposed conjugate of the

$$\vert {ψ}_{j} 〉 := \vert j 〉 ⊗ \frac{1}{\sqrt{d}} {\sum }_{k ∈ [ N ] : {A}_{jk} \neq 0} ( \sqrt{{A}_{jk}^{*}} \vert k 〉 + \sqrt{1 - \vert {A}_{jk} \vert} \vert k + N 〉 ) ,$$

and I_{4N}_{²} is a 4N²-dimensional identity matrix; constructing a quantum circuit that implements a third functional module V⁺, where the third functional module is a transposed conjugate form of the first functional module; and sequentially inserting the first functional module, the second functional module and the third functional module into the quantum circuit to form the quantum circuit corresponding to the quantum linear solution algorithm.

In a second aspect, an embodiment of the present application further provides an apparatus for solving a system of nonlinear ordinary differential equations on the basis of a quantum circuit, including: an acquisition module configured to acquire information about a system of nonlinear ordinary differential equations to be processed; a conversion module configured to convert the system of nonlinear ordinary differential equations to be processed to obtain a target system of linear ordinary differential equations; a construction module configured to construct a quantum circuit corresponding to a quantum linear solution algorithm, and perform quantum state evolution and measurement on the target system of linear ordinary differential equations, to acquire a solution of the target system of linear ordinary differential equations; a calculation module configured to calculate, according to the solution of the target system of linear ordinary differential equations, a solution of the nonlinear ordinary differential equations to be processed.

In one embodiment, the conversion module includes: a first conversion unit configured to convert the system of nonlinear ordinary differential equations to be processed into a preset type of system of nonlinear ordinary differential equations in a homotopy perturbation method; and a second conversion unit configured to convert the preset type of system of nonlinear ordinary differential equations into the target system of linear ordinary differential equations in a linear embedding method.

In one embodiment, the construction module includes: a first construction unit configured to construct a quantum circuit that implements a first functional module V, where the first functional module is defined as

$$V \vert {0}^{m} 〉 := \frac{1}{\sqrt{α}} {\sum }_{i} \sqrt{α} \vert i 〉 , α := 4 {\sum }_{j = 0}^{j 0} {( - 1 )}^{j} \frac{{\sum }_{i = j + 1}^{b} ( \begin{matrix}2 b \\ b + j\end{matrix} )}{{2}^{2 b}} , {j}_{0} = \sqrt{b log ( 4 b / ϵ )} , b = {κ}^{2} log ( κ / ϵ ) ;$$

a second construction unit configured to construct a quantum circuit that implements a second functional module combination, where the quantum circuit for the second functional module combination includes T, W and T⁺, the T=Σ_{j∈[N]}|Ψⱼ [symbol] j|, W=S·(2T·T⁺−I_{4N}_{²}), the S is a unitary matrix of an exchange operation module, the T⁺ is a transposed conjugate of the T, the

$$\vert {Ψ}_{j} 〉 := \vert j 〉 ⊗ \frac{1}{\sqrt{d}} {\sum }_{k ∈ [ N ] : {A}_{jk} \neq 0} ( \sqrt{{A}_{jk}^{*}} \vert k 〉 + \sqrt{1 - \vert {A}_{jk} \vert} \vert k + N 〉 ) ,$$

and I_{4N}_{²} is a 4N²-dimensional identity matrix; a third construction unit configured to construct a quantum circuit that implements a third functional module V⁺, where the third functional module is a transposed conjugate form of the first functional module; and a combination unit configured to sequentially insert the first functional module, the second functional module and the third functional module into the quantum circuit to form the quantum circuit corresponding to the quantum linear solution algorithm.

In a third aspect, the present disclosure further provides a storage medium having a computer program stored thereon, where the computer program is configured to, when executed, cause any one of the methods described above to be implemented.

In a fourth aspect, the present disclosure further provides an electronic device, including a memory and a processor, where the memory has a computer program stored thereon, and the processor is configured to execute the computer program to implement any one of the methods described above.

According to the above solutions of the present disclosure, information about a system of nonlinear ordinary differential equations to be processed is firstly acquired, then the system of nonlinear ordinary differential equations to be processed is converted to obtain a target system of linear ordinary differential equations, a quantum circuit corresponding to a quantum linear solution algorithm is constructed, and quantum state evolution and measurement are performed on the target system of linear ordinary differential equations, to acquire a solution of the target system of linear ordinary differential equations, and according to the solution of the target system of linear ordinary differential equations, a solution of the nonlinear ordinary differential equations to be processed is calculated. Therefore, by means of related properties of quantum, the technology of solving a system of nonlinear ordinary differential equations with a quantum algorithm can be implemented, and the complexity and difficulty in solving the system of nonlinear ordinary differential equations can be reduced, thereby filling in related technical gaps in the field of quantum computation.

In order to solve at least one or more technical problems described in the background section, the present disclosure proposes a method and an apparatus for solving a system of quadratic nonlinear equations on the basis of a quantum circuit to address deficiencies in the existing art, which can implement the technology of solving a system of quadratic nonlinear equations with a quantum algorithm, and reduce the complexity and difficulty in solving a system of quadratic nonlinear equations, thereby filling in related technical gaps in the field of quantum computation. In view of this, the present disclosure provides solutions in the following aspects.

In a first aspect, the present disclosure provides a method for solving a system of quadratic nonlinear equations on the basis of a quantum circuit, including:

acquiring a target system of linear equations, where the target system of linear equations is converted and determined from an initial system of quadratic nonlinear equations; constructing a quantum circuit corresponding to a quantum linear solver, and running the quantum circuit and measuring, to solve the target system of linear equations; determining, based on an obtained solution of the target system of linear equations, a solution of the initial system of quadratic nonlinear equations.

In one embodiment, the initial system of quadratic nonlinear equations is specifically:

$${F}_{0} + {F}_{1} x + {F}_{2} {x}^{⊗ {}_{2}} = 0$$

where x∈Rⁿ, R represents real number space, Fᵢ∈Rⁿ×Rⁿ^{ⁱ}, and F₁ and F₂ each have a sparsity s.

In one embodiment, acquiring the target system of linear equations includes: converting the initial system of quadratic nonlinear equations into a preset system of pseudo-linear equations in a homotopy perturbation method; converting the preset system of pseudo-linear equations into a target system of linear equations in a linear embedding method.

In one embodiment, the preset system of pseudo-linear equations is:

$${v}_{0} = - {F}_{1}^{- 1} {F}_{0} \\ {v}_{1} = - {F}_{1}^{- 1} {F}_{2} ( {v}_{0} ⊗ {v}_{0} ) \\ {v}_{2} = - {F}_{1}^{- 1} {F}_{2} ( {v}_{0} ⊗ {v}_{1} + {v}_{1} ⊗ {v}_{0} ) \\ … \\ {v}_{c} = - {F}_{1}^{- 1} {F}_{2} {\sum }_{j = 0}^{j = c - 1} {v}_{j} ⊗ {v}_{c - 1 - j}$$

where F₁ is invertible, vᵢ is a variable to be solved in the preset system of pseudo-linear equations, 0≤i≤c, and the c is the number of variables to be solved in the preset system of pseudo-linear equations.

In one embodiment, the target system of linear equations is:

$$[ \begin{matrix}{A}_{0 , 0} & {A}_{0 , 1} & 0 & 0 & 0 & 0 \\ 0 & {A}_{1 , 1} & {A}_{1 , 2} & 0 & 0 & 0 \\ 0 & 0 & {A}_{2 , 2} & ⋱ & 0 & 0 \\ 0 & 0 & 0 & ⋱ & {A}_{c - 1 , c - 2} & 0 \\ 0 & 0 & 0 & 0 & {A}_{c - 1 , c - 1} & {A}_{c - 1 , c} \\ 0 & 0 & 0 & 0 & 0 & {A}_{c , c}\end{matrix} ] [ \begin{matrix}{y}_{0} \\ {y}_{1} \\ {y}_{2} \\ ⋮ \\ {y}_{c - 1} \\ {y}_{c}\end{matrix} ] = [ \begin{matrix}{b}_{0} \\ {b}_{1} \\ {b}_{2} \\ ⋮ \\ {b}_{c - 1} \\ {b}_{c}\end{matrix} ]$$

where A_{j,i} is a

$${n}^{i + 1} {\sum }_{j = i}^{c} ( \begin{matrix}j \\ i\end{matrix} ) \times {n}^{i + 1} {\sum }_{j = i}^{c} ( \begin{matrix}j \\ i\end{matrix} )$$

dimension matrix, A_{i,i+1} is a nⁱ⁺¹βᵢ×nⁱ⁺²βᵢ₊₁ dimension matrix, y=y₀, y₁, . . . , y_{c}, yᵢ satisfies y₀=v₀+v₁+v₂+ . . . +v_{c}, yᵢ=[y_{i,0}, y_{i,1}, y_{i,2}, . . . , y_{i,β}_{ᵢ}₋₁], and βᵢ represents the number of items in yᵢ.

In one embodiment, constructing the quantum circuit corresponding to the quantum linear solver includes: constructing a quantum circuit that implements a first functional module V, where the first functional module is defined as

$$V \vert {0}^{m} 〉 := \frac{1}{\sqrt{α}} {\sum }_{i} \sqrt{α} \vert i 〉 , α := 4 {\sum }_{j = 0}^{j 0} {( - 1 )}^{j} \frac{{\sum }_{i = j + 1}^{b} ( \begin{matrix}2 b \\ b + i\end{matrix} )}{{2}^{2 b}} , {j}_{0} = \sqrt{b log ( 4 b / ϵ )} , b = {κ}^{2} log ( κ / ϵ ) ;$$

constructing a quantum circuit that implements a second functional module combination, where the quantum circuit for the second functional module combination includes T, W and T⁺, the T=Σ_{j∈[N]}|Ψⱼ [symbol] j|, W=S·(2T·T⁺−I_{4N}_{²}), the S is a unitary matrix of an exchange operation module, the T⁺ is a transposed conjugate of the T, the

$$\vert {ψ}_{j} 〉 := \vert j 〉 ⊗ \frac{1}{\sqrt{d}} {\sum }_{k ∈ [ N ] : {A}_{jk} \neq 0} ( \sqrt{{A}_{jk}^{*}} \vert k 〉 + \sqrt{1 - \vert {A}_{jk} \vert} \vert k + N 〉 ) ,$$

and I_{4N}_{²} is a 4N²-dimensional identity matrix; constructing a quantum circuit that implements a third functional module V⁺, where the third functional module is a transposed conjugate form of the first functional module; and sequentially inserting the first functional module, the second functional module and the third functional module into the quantum circuit to form the quantum circuit corresponding to the quantum linear solver.

In a second aspect, the present disclosure provides an apparatus for solving a system of quadratic nonlinear equations on the basis of a quantum circuit, including: an acquisition module configured to acquire a target system of linear equations, where the target system of linear equations is converted and determined from an initial system of quadratic nonlinear equations; a construction module configured to construct a quantum circuit corresponding to a quantum linear solver, and run the quantum circuit and measure, to solve the target system of linear equations; and a determination module configured to determine, based on an obtained solution of the target system of linear equations, a solution of the initial system of quadratic nonlinear equations.

In one embodiment, the acquisition module includes: a first conversion unit configured to convert the initial system of quadratic nonlinear equations into a preset system of pseudo-linear equations in a homotopy perturbation method; and a second conversion unit configured to convert the preset system of pseudo-linear equations into a target system of linear equations in a linear embedding method.

In one embodiment, the construction module includes: a first construction unit configured to construct a quantum circuit that implements a first functional module V, where the first functional module is defined as

$$V \vert {0}^{m} 〉 := \frac{1}{\sqrt{α}} {\sum }_{i} \sqrt{α} \vert i 〉 , α := 4 {\sum }_{j = 0}^{j 0} {( - 1 )}^{j} \frac{{\sum }_{i = j + 1}^{b} ( \begin{matrix}2 b \\ b + i\end{matrix} )}{{2}^{2 b}} ,$$

j₀=\sqrt{blog(4b/ϵ)}, b=κ² log (κ/ϵ); a second construction unit configured to construct a quantum circuit that implements a second functional module combination, where the quantum circuit for the second functional module combination includes T, W and T⁺, the T=Σ_{j∈[N]}|Ψⱼ [symbol] j|, W=S·(2T·T⁺−I_{4N}_{²}), the S is a unitary matrix of an exchange operation module, the T⁺ is a transposed conjugate of the T, the

$$\vert {ψ}_{j} 〉 := \vert j 〉 ⊗ \frac{1}{\sqrt{d}} {\sum }_{k ∈ [ N ] : {A}_{jk} \neq 0} ( \sqrt{{A}_{jk}^{*}} \vert k 〉 + \sqrt{1 - \vert {A}_{jk} \vert} \vert k + N 〉 ) ,$$

and I_{4N}_{²} is a 4N²-dimensional identity matrix; a third construction unit configured to construct a quantum circuit that implements a third functional module V⁺, where the third functional module is a transposed conjugate form of the first functional module; and a combination unit configured to sequentially insert the first functional module, the second functional module and the third functional module into the quantum circuit to form the quantum circuit corresponding to the quantum linear solver.

In a third aspect, the present disclosure provides a storage medium having a computer program stored thereon, where the computer program is configured to, when executed, cause any one of the methods described above to be implemented.

In a fourth aspect, the present disclosure provides an electronic device, including a memory and a processor, where the memory has a computer program stored thereon, and the processor is configured to execute the computer program to implement any one of the methods described above.

According to the above solutions of the present disclosure, a target system of linear equations is firstly converted and determined according to an initial system of quadratic nonlinear equations, then a quantum circuit corresponding to a quantum linear solver is constructed, and the quantum circuit is run and measurement is performed to solve the target system of linear equations, and the solution of the initial system of quadratic nonlinear equations is determined based on the solved solution of the target system of linear equations. Therefore, by means of related properties of quantum, the technology of solving a system of quadratic nonlinear equations with a quantum algorithm can be implemented, and the complexity and difficulty in solving the system of quadratic nonlinear equations can be reduced, thereby filling in related technical gaps in the field of quantum computation.

0 In order to solve at least one or more technical problems described in the background section, the present disclosure proposes a method, an apparatus, a medium and an electronic device for solving a system of linear equations, which aim to reduce the complexity in solving linear system problems, and achieve an acceleration effect in solving linear system problems with quantum. In view of this, the present disclosure provides solutions in the following aspects.

In a first aspect, the present disclosure provides a method for solving a system of linear equations, including: acquiring a matrix A and a vector b in the system of linear equations Ax=b, where the x is an unknown; when a condition number κ_{A} of the matrix A is greater than a preset threshold, processing the matrix A and the vector b through a polynomial preprocessor to obtain a matrix A′ and a vector b′, where a condition number κ_{A}′ of the matrix A′ is less than the condition number KA of the matrix A; and solving the unknown x through a system of linear equations A′x=b′ constructed from the matrix A′ and the vector b′.

In one embodiment, processing the matrix A and the vector b through the polynomial preprocessor to obtain the matrix A′ and the vector b′ includes: preparing a quantum state |b) of the vector b, and determining a polynomial P(A) based on a polynomial function P(y) and the matrix A, where the y is an independent variable; constructing an operator P̅ based on the polynomial P(A), and multiplying the polynomial P(A) by the matrix A to obtain a matrix A′; and applying the operator P̅ to the quantum state |b) to obtain a quantum state |b′), where the quantum state |b′) is a quantum state corresponding to a vector b′.

In one embodiment, before determining the polynomial P(A) based on the polynomial function P(y) and the matrix A, the method further includes: acquiring an approximate function Kₘ(y) containing parameters, and determining a domain of definition of the approximate function Kₘ(y) containing parameters;

selecting m+2 approximate deviation points from the domain of definition, and substituting the m+2 approximate deviation points into a relational expression composed of the approximate function Kₘ(y) containing parameters and a deviation amplitude E, to obtain a m+2-dimensional system of linear equations Kₘ(yₖ)−T=(−1)^{k+1}E, where k=0,1,2 . . . m+1, the m is an integer greater than 0, and the Tis any natural number in the domain of definition; solving the system of linear equations Kₘ(yₖ)−T=(−1)^{k+1}E, to obtain a value of a parameter in the approximate function Kₘ(y) containing parameters; determining a target approximate function based on the value of the parameter, and determining the polynomial function P(y) based on the target approximate function.

In one embodiment, determining the target approximation function based on the value of the parameter includes: substituting the value of the parameter into the approximate function Kₘ(y) containing parameters to obtain an initial approximate function; determining an extreme point of an absolute value of a difference between the initial approximation function and the T; if the extreme point and the m+2 approximation deviation points are equal within an accuracy requirement, determining the initial approximation function as the target approximation function; if the extreme point and the m+2 approximation deviation points are not equal within the accuracy requirement, taking the extreme point as a new point of the m+2 approximate deviation points, and performing the step of substituting the m+2 approximate deviation points into the relational expression composed of the approximate function Kₘ(y) containing parameters and the deviation amplitude E to obtain the m+2-dimensional system of linear equations Kₘ(yₖ)−T=(−1)^{k+1}E.

In one embodiment, determining the polynomial function P(y) based on the target approximate function includes: determining, based on a relational expression P(y)=K(y)/f(y) of the target approximation function and the polynomial function P(y), the polynomial function P(y), where the f(y)=y.

In one embodiment, if the approximate function Kₘ(y) containing parameters is an even function, the Kₘ(y)=Σᵢ₌₀^{m}θ₂ᵢy²ⁱ⁺¹; and if the approximate function Kₘ(y) containing parameters is an odd function, the Kₘ(y)==Σᵢ₌₀^{m}θ₂ᵢy²ⁱ⁺¹; where the θ₂ᵢ, θ₂ᵢ₊₁ are parameters, and the i is an integer greater than or equal to 0.

In one embodiment, constructing the operator P̅ based on the polynomial P(A) includes: preparing the operator P̅ corresponding to the polynomial P(A) through quantum signal processing (QSP).

In one embodiment, solving the unknown x through the system of linear equations A′x=b′ constructed from the matrix A′ and the vector b′ includes: determining an operator U̅ for a Harrow-Hassidim-Lloyd algorithm (HHL) algorithm based on the matrix A′; inputting the quantum state |b′) corresponding to the vector b′ and the operator U̅ to the HHL algorithm, to determine a target quantum state including values of the unknown x; and determining a solution result of the unknown x based on the target quantum state.

In one embodiment, determining the operator U for the HHL algorithm based on the matrix A′ includes:

determining the operator U̅=e^{iA′t} for the HHL algorithm; expanding the operator U̅=e^{iA′t} according to the Jacobi-Anger expansion to determine an exponential expansion of the operator U, where the exponential expansion of the operator U̅ is:

$${e}^{i γ t} = {J}_{0} ( t ) + 2 {\sum }_{k = 1}^{∞} {( - 1 )}^{k} {J}_{2 k} ( t ) {T}_{2 k} ( γ ) + 2 i {\sum }_{k = 0}^{∞} {( - 1 )}^{k} {J}_{2 k + 1} ( t ) {T}_{2 k} ( γ ) ,$$

where Jₖ is a k^{th} order Bessel function of the first kind, and Tₖ is a k^{th} order Chebyshev polynomial of the first kind; saving the exponential expansion of the operator U̅ in accuracy of a q^{th} order, where the exponential expansion of the operator U in accuracy of the q^{th} order is:

$${e}^{i γ t} = {f}_{1} ( γ , t ) + {f}_{2} ( γ , t ) , \\ where \\ {f}_{1} ( γ , t ) = {J}_{0} ( t ) + 2 {\sum }_{k = 1}^{q} {( - 1 )}^{k} {J}_{2 k} ( t ) {T}_{2 k} ( γ ) , \\ {f}_{2} ( γ , t ) = 2 i {\sum }_{k = 1}^{q} {( - 1 )}^{k} {J}_{2 k + 1} ( t ) {T}_{2 k} ( γ ) , and \\ γ = P ( A ) A ;$$

preparing an operator f̅₁ corresponding to f₁(γ,t) and an operator f̅₂ corresponding to f₂(γ, t) through the QSP; and

constructing the operator U̅ through linear combination of unitary operators (LCU), the operator f̅₁ and the operator f̅₂.

In a second aspect, an embodiment of the present application further provides an apparatus for solving a system of linear equations, including: an acquisition unit configured to acquire a matrix A and a vector b in the system of linear equations Ax=b, where the x is an unknown; a processing unit configured to, when a condition number KA of the matrix A is greater than a preset threshold, process the matrix A and the vector b through a polynomial preprocessor to obtain a matrix A′ and a vector b′, where a condition number KA′ of the matrix A′ is less than the condition number KA of the matrix A; and a calculation unit configured to solve the unknown x through a new system of linear equations A′x=b′ constructed from the matrix A′ and the vector b′.

In one embodiment, in the aspect of processing the matrix A and the vector b through the polynomial preprocessor to obtain the matrix A′ and the vector b′, the processing unit is specifically configured to: prepare a quantum state |b) of the vector b, and determine a polynomial P(A) based on a polynomial function P(y) and the matrix A, where the y is an independent variable; construct an operator P̅ based on the polynomial P(A), and multiply the polynomial P(A) by the matrix A to obtain a matrix A′; and apply the operator P̅ to the quantum state |b [symbol] to obtain a quantum state |b′ [symbol] , where the quantum state |b′) is a quantum state corresponding to a vector b′.

In one embodiment, before determining the polynomial P(A) based on the polynomial function P(y) and the matrix A, the processing unit is further configured to: acquire an approximate function Kₘ(y) containing parameters, and determine a domain of definition of the approximate function Kₘ(y) containing parameters; select m+2 approximate deviation points from the domain of definition, and substitute the m+2 approximate deviation points into a relational expression composed of the approximate function Kₘ(y) containing parameters and a deviation amplitude E, to obtain a m+2-dimensional system of linear equations Kₘ(yₖ)−T=(−1)^{k+1}E, where k=0,1,2 . . . m+1, the m is an integer greater than 0, and the T is any natural number in the domain of definition; solve the system of linear equations Kₘ(yₖ)−T=(−1)^{k+1}E, to obtain a value of a parameter in the approximate function Kₘ(y) containing parameters; determine a target approximate function based on the value of the parameter, and determine the polynomial function P(y) based on the target approximate function.

In one embodiment, in the aspect of determining the target approximate function based on the value of the parameter, the processing unit is specifically configured to: substitute the value of the parameter into the approximate function Kₘ(y) containing parameters to obtain an initial approximate function; determine an extreme point of an absolute value of a difference between the initial approximation function and the T; if the extreme point and the m+2 approximation deviation points are equal within an accuracy requirement, determine the initial approximate function as the target approximate function; if the extreme point and the m+2 approximation deviation points are not equal within the accuracy requirement, take the extreme point as a new point of the m+2 approximate deviation points, and perform the step of substituting the m+2 approximate deviation points into the relational expression composed of the approximate function Kₘ(y) containing parameters and the deviation amplitude E to obtain the m+2-dimensional system of linear equations Kₘ(yₖ)−T=(−1)^{k+1}E.

In one embodiment, in the aspect of determining the polynomial function P(y) based on the target approximate function, the processing unit is specifically configured to: determine, based on a relational expression P(y)=K(y)/f(y) of the target approximation function and the polynomial function P(y), the polynomial function P(y), where the f(y)=y.

In one embodiment, if the approximate function Kₘ(y) containing parameters is an even function, the Kₘ(y)=Σᵢ₌₀^{m}θ₂ᵢy²ⁱ⁺¹; and if the approximate function Kₘ(y) containing parameters is an odd function, the Kₘ(y)=Σᵢ₌₀^{m}θ₂ᵢy²ⁱ⁺¹; and the θ₂ᵢ, θ₂ᵢ₊₁ are parameters, and the i is an integer greater than or equal to 0.

In one embodiment, in the aspect of constructing the operator P̅ based on the polynomial P(A), the processing unit is specifically configured to: prepare the operator P̅ corresponding to the polynomial P(A) through quantum signal processing (QSP).

In one embodiment, in the aspect of solving the unknown x through the system of linear equations A′x=b′ constructed from the matrix A′ and the vector b′, the calculation unit is specifically configured to: determine an operator U̅ for an HHL algorithm based on the matrix A′;

input the quantum state |b′) corresponding to the vector b′ and the operator U to the HHL algorithm, to determine a target quantum state including a value of the unknown x; and determine a solution result of the unknown x based on the target quantum state.

In one embodiment, in the aspect of determining the operator U for the HHL algorithm based on the matrix A′, the calculation unit is specifically configured to: determine the operator U̅=e^{iA′t} for the HHL algorithm; expand the operator U̅=e^{iA′t} according to the Jacobi-Anger expansion to determine an exponential expansion of the operator U̅, where the exponential expansion of the operator U̅ is:

$${e}^{i γ t} = {J}_{0} ( t ) + 2 {\sum }_{k = 1}^{∞} {( - 1 )}^{k} {J}_{2 k} ( t ) {T}_{2 k} ( γ ) + 2 i {\sum }_{k = 0}^{∞} {( - 1 )}^{k} {J}_{2 k + 1} ( t ) {T}_{2 k} ( γ ) ,$$

where Jₖ is a k^{th} order Bessel function of the first kind, and Tₖ is a k^{th} order Chebyshev polynomial of the first kind; save the exponential expansion of the operator U in precision of a q^{th} order, where the exponential expansion of the operator U in accuracy of the q^{th} order is:

$${e}^{i γ t} = {f}_{1} ( γ , t ) + {f}_{2} ( γ , t ) , \\ where \\ {f}_{1} ( γ , t ) = {J}_{0} ( t ) + 2 {\sum }_{k = 1}^{q} {( - 1 )}^{k} {J}_{2 k} ( t ) {T}_{2 k} ( γ ) , \\ {f}_{2} ( γ , t ) = 2 i {\sum }_{k = 0}^{q} {( - 1 )}^{k} {J}_{2 k + 1} ( t ) {T}_{2 k} ( γ ) , and \\ γ = P ( A ) A ;$$

prepare an operator f̅₁ corresponding to f₁(γ,t) and an operator f̅₂ corresponding to f₂(γ, t) through the QSP; and construct the operator U through linear combination of unitary operators (LCU), the operator f̅₁ and the operator f̅₂.

In a third aspect, the present disclosure further provides a storage medium having a computer program stored thereon, where the computer program is configured to, when executed, cause any one of the methods described above to be implemented.

In a fourth aspect, the present disclosure further provides an electronic device, including a memory and a processor, where the memory has a computer program stored thereon, and the processor is configured to execute the computer program to implement any one of the methods described above.

According to the above solutions of the present disclosure, a matrix A and a vector b in an original system of linear equations Ax=b are processed through a polynomial preprocessor to obtain a new system of linear equations A′x=b′, and a condition number κ_{A}′ of the matrix A′ in the new system of linear equations is less than the condition number κ_{A} of the matrix A in the original system of linear equations, so that the condition number of the input matrix, and thus the complexity of the linear system problem, are reduced. Then, the new system of linear equations is solved to obtain a common unknown x, so that an acceleration effect in solving linear system problems with quantum is achieved.

In order to solve at least one or more technical problems described in the background section, the present disclosure proposes a quantum linear solution method based on a polynomial preprocessor, which can reduce the time, complexity and computation amount in solving linear problems while reducing occupation of hardware resources. In view of this, the present disclosure provides solutions in the following aspects.

In a first aspect, the present disclosure provides a quantum linear solution method based on a polynomial preprocessor, including: acquiring information of a first matrix A and a first vector b in a linear system to be processed; calculating a polynomial p(A) of the first matrix A used for preprocessing the linear system; pre-processing the linear system according to the polynomial p(A) to obtain a second matrix A′ and a second vector b′; and constructing a quantum circuit corresponding to an HHL algorithm, and performing, according to the second matrix A′ and the second vector b′, quantum state evolution and measurement operations to obtain a final quantum state of the evolved quantum circuit.

In one embodiment, obtaining the second matrix A′ and the second vector b′ includes: obtaining a second matrix A′=p(A) A and a second vector b′=p(A)b.

In one embodiment, performing, according to the second matrix A′ and the second vector b′, quantum state evolution and measurement operations to obtain the final quantum state of the evolved quantum circuit includes: inputting, for the quantum circuit, an initial quantum state |b′) and an operator U, and performing quantum state evolution and measurement operations to obtain the final quantum state of the evolved quantum circuit, where the operator U=e^{iA′t}, and the t is a constant.

In one embodiment, calculating the polynomial p(A) of the first matrix A used for preprocessing the linear system includes: constructing a function ƒₘ(x) and a preset interval S for solving the polynomial, where the function ƒₘ(x) satisfies fₘ(x)=pₘ(x)x, and fₘ(xᵢ)+(−1)ⁱE=1, the m is a polynomial order, the i=0,1,2, . . . , m+1, the S∈[1/κ_{A}, 1], the E is a deviation amplitude, and the κ_{A} is a condition number; selecting m+1 points in the preset interval, and acquiring a solution of a system of linear equations fₘ(xᵢ)+(−1)ⁱE=1, where the m+1 points are respectively x₁, x₂, . . . , xₘ₊₁, and satisfy x₁=1/κ, xₘ₊₁=1; substituting the acquired solution of the system of linear equations into fₘ(x) to obtain a set N′ of points corresponding to local maximum values of |1−fₘ(x)|; and judging whether an absolute value of fₘ(x)−1 is the same for any x∈N′, and whether a sign of fₘ(x)−1 changes between plug and minus alternately as x increases, if the absolute value of fₘ(x)−1 is the same for any x∈N′, and the sign of fₘ(x)−1 changes between plug and minus alternately as x increases, determining a current fₘ(x) as an optimal polynomial.

In one embodiment, the method further includes: if the absolute value of fₘ(x)−1 is not the same for any x∈N′, or the sign of fₘ(x)−1 does not change between plug and minus alternately as x increases, replacing elements in x₁, x₂, . . . , xₘ₊₁ with elements in the set N′ according to a rule including: replacing x₂, . . . , xₘ with elements in the set N′ while x₁, xₘ₊₁ remain unchanged, and then returning to perform the step of acquiring a solution of the system of linear equations fₘ(xᵢ)+(−1)ⁱE=1, until an optimal fₘ(x) satisfying the judgment condition is obtained.

In one embodiment, constructing the quantum circuit corresponding to the HHL algorithm includes: obtaining several qubits including an auxiliary qubit, a first qubit, and a second qubit, where initial states of the auxiliary qubit and the first qubit are set to |0 [symbol] , an initial state of the second qubit is set to |b′ [symbol] =Σᵢ₌₁^{N}b′ᵢ|i [symbol] , the bᵢ′ is an i^{th} element of the second vector b′, and the N is a dimension number of the second vector; determining a unitary matrix U̅ corresponding to the second matrix A′; constructing a first sub-quantum circuit module for phase estimation, which is used to decompose the |b′ [symbol] into |b′ [symbol] =Σⱼ₌₁^{N}βⱼ|μⱼ [symbol] in eigenspace of the second matrix A′, and transforming the initial state |0 [symbol] |b′ [symbol] of the first qubit and the second qubit into Σⱼ₌₁^{N}βⱼ|λⱼ [symbol] |μⱼ [symbol] , where the |μⱼ [symbol] is an eigenvector of the second matrix A′, the λⱼ is an eigenvalue of the second matrix A′, and the βⱼ is an eigenvector amplitude of the second matrix A′; constructing a second sub-quantum circuit module for performing a controlled rotation operation, which is used to rotate the auxiliary qubit with |λⱼ [symbol] as a control bit to obtain

$${\sum }_{j = 1}^{N} {β}_{j} \vert {λ}_{j} 〉 \vert {μ}_{j} 〉 ( \sqrt{1 - \frac{{c}^{2}}{{λ}_{j}^{2}}} \vert 0 〉 + \frac{c}{{λ}_{j}} \vert 1 〉 ) ,$$

where the C is a normalization constant; constructing a third sub-quantum circuit module for performing inverse phase estimation, which is used to reset |λⱼ [symbol] to |0 [symbol] ; constructing a measurement operation module for the auxiliary qubit, so that when the measured quantum state of the auxiliary qubit is (1 [symbol] :

$$\vert {x}^{′} 〉 = \frac{1}{\sqrt{{\sum }_{j = 1}^{N} {( C {λ}_{j}^{- 1} {β}_{j} )}^{2}}} {\sum }_{j = 1}^{N} C {λ}_{j}^{- 1} {β}_{j} \vert {μ}_{j} 〉 ,$$

and the |x′ [symbol] ∝|x [symbol] ; and sequentially forming the first sub-quantum circuit module, the second sub-quantum circuit module, the third sub-quantum circuit module, and the quantum measurement operation module into the quantum circuit corresponding to the HHL algorithm.

In a second aspect, an embodiment of the present application further provides a quantum linear solution apparatus based on a polynomial preprocessor, including: an acquisition module configured to acquire information of a first matrix A and a first vector b in a linear system to be processed; a calculation module configured to calculate a polynomial p(A) of the first matrix A used for preprocessing the linear system; an obtaining module configured to pre-process the linear system according to the polynomial p(A), to obtain a second matrix A′ and a second vector b′; and a construction module configured to construct a quantum circuit corresponding to an HHL algorithm, and perform, according to the second matrix A′ and the second vector b′, quantum state evolution and measurement operations to obtain a final quantum state of the evolved quantum circuit.

In one embodiment, the obtaining module includes: a first obtaining unit configured to obtain a second matrix A′=p(A) A and a second vector b′=p(A)b.

In one embodiment, the construction module includes: an input unit configured to input for the quantum circuit, an initial quantum state |b′) and an operator U, and perform quantum state evolution and measurement operations to obtain the final quantum state of the evolved quantum circuit, where the operator U̅=e^{iA′t}, and the t is a constant.

In one embodiment, the calculation module includes: a first construction unit configured to construct a function ƒₘ(x) and a preset interval S for solving the polynomial, where the function ƒₘ(x) satisfies fₘ(x)=pₘ (x)x, and fₘ(xᵢ)+(−1)ⁱE=1, the m is a polynomial order, the i=0,1,2, . . . , m+1, the S∈[1/κ_{A}, 1], the E is a deviation amplitude, and the κ_{A} is a condition number; a selection unit configured to select m+1 points in the preset interval, and acquire a solution of a system of linear equations fₘ(xᵢ)+(−1)ⁱE=1, where the m+1 points are respectively x₁, x₂, . . . , xₘ₊₁, and satisfy x₁=1/κ, xₘ₊₁=1; a substitution unit configured to substitute the acquired solution of the system of linear equations into fₘ(x) to obtain a set N′ of points corresponding to local maximum values of |1−fₘ(x)|; and a judgment unit configured to judge whether an absolute value of fₘ(x)−1 is the same for any x∈N′, and whether a sign of fₘ(x)−1 changes between plug and minus alternately as x increases, if the absolute value of fₘ(x)−1 is the same for any x∈N′, and the sign of fₘ(x)−1 changes between plug and minus alternately as x increases, determine a current fₘ(x) as an optimal polynomial.

In one embodiment, the calculation module further includes: a return unit configured to, if the absolute value of fₘ(x)−1 is not the same for any x∈N′, or the sign of fₘ(x)−1 does not change between plug and minus alternately as x increases, replace elements in x₁, x₂, . . . , xₘ₊₁ with elements in the set N′ according to a rule including: replace x₂, . . . , xₘ with elements in the set N′ while x₁, xₘ₊₁ remain unchanged, and then return to perform the step of acquiring a solution of the system of linear equations fₘ(xᵢ)+(−1)ⁱE=1, until an optimal fₘ(x) meeting a judgment condition is obtained.

In one embodiment, the construction module includes: a second obtaining unit configured to obtain several qubits including an auxiliary qubit, a first qubit, and a second qubit, where initial states of the auxiliary qubit and the first qubit are set to |0), an initial state of the second qubit is set to |b′ [symbol] =Σᵢ₌₁^{N}b′ᵢ|i [symbol] , the bⱼ′ is an i^{th} element of the second vector b′, and the N is a dimension number of the second vector; a determination unit configured to determine a unitary matrix U̅ corresponding to the second matrix A′; a second construction unit configured to construct a first sub-quantum circuit module for phase estimation, which is used to decompose the |b′ [symbol] into |b′ [symbol] =Σⱼ₌₁^{N}βⱼ|μⱼ [symbol] in eigenspace of the second matrix A′, and transform the initial state |0 [symbol] |b′ [symbol] of the first qubit and the second qubit into Σⱼ₌₁^{N}βⱼ|λⱼ|μⱼ [symbol] , where the |μⱼΣⱼ₌₁^{N}βⱼ|λⱼ|μⱼ [symbol] is an eigenvector of the second matrix A′, the λⱼ is an eigenvalue of the second matrix A′, and the βⱼ is an eigenvector amplitude of the second matrix A′; a third construction unit configured to construct a second sub-quantum circuit module for performing a controlled rotation operation, which is used to rotate the auxiliary qubit with |λⱼ [symbol] as a control bit to obtain

$${\sum }_{j = 1}^{N} {β}_{j} \vert {λ}_{j} 〉 \vert {μ}_{j} 〉 ( \sqrt{1 - \frac{{c}^{2}}{{λ}_{j}^{2}}} \vert 0 〉 + \frac{c}{{λ}_{j}} \vert 1 〉 ) ,$$

where the C is a normalization constant; a fourth construction unit configured to construct a third sub-quantum circuit module for performing inverse phase estimation, which is used to reset |λⱼ [symbol] to |0 [symbol] ; a fifth construction unit configured to construct a measurement operation module for the auxiliary qubit, so

$$\vert {x}^{′} 〉 = \frac{1}{\sqrt{{\sum }_{j = 1}^{N} {( C {λ}_{j}^{- 1} {β}_{j} )}^{2}}} {\sum }_{j = 1}^{N} C {λ}_{j}^{- 1} {β}_{j} \vert {μ}_{j} 〉 ,$$

and the |x′ [symbol] ∝|x [symbol] ; and a combination unit configured to sequentially form the first sub-quantum circuit module, the second sub-quantum circuit module, the third sub-quantum circuit module, and the quantum measurement operation module into the quantum circuit corresponding to the HHL algorithm.

In a third aspect, the present disclosure further provides a storage medium having a computer program stored thereon, where the computer program is configured to, when executed, cause any one of the methods described above to be implemented.

In a fourth aspect, the present disclosure further provides an electronic device, including a memory and a processor, where the memory has a computer program stored thereon, and the processor is configured to execute the computer program to implement any one of the methods described above.

According to the above solutions of the present disclosure, information of a first matrix A and a first vector b in a linear system to be processed is firstly acquired, a polynomial p(A) of the first matrix A used for preprocessing the linear system is calculated, the linear system is pre-processed according to the polynomial p(A), to obtain a second matrix A′ and a second vector b′, a quantum circuit corresponding to an HHL algorithm is constructed, and according to the second matrix A′ and the second vector b′, quantum state evolution and measurement operations are performed to obtain a final quantum state of the evolved quantum circuit, which can reduce the time, complexity and computation amount in solving linear problems and speed up solution of the quantum linear algorithm, while reducing occupation of hardware resources.

### BRIEF DESCRIPTION OF THE DRAWINGS

The description and other objects, features and advantages of the exemplary implementations of the present disclosure will become apparent from the following detailed description with reference to the accompanying drawings. In the accompanying drawings, several implementations of the present disclosure are illustrated by way of example but not limitation, and like or corresponding reference numerals indicate like or corresponding parts, in which:

FIG. 1 is a block diagram showing a hardware structure of a computer terminal for solving a system of nonlinear equations on the basis of a quantum circuit according to an embodiment of the present disclosure;

FIG. 2 is a schematic flowchart of a method for solving a system of nonlinear equations on the basis of a quantum circuit according to an embodiment of the present disclosure;

FIG. 3 is a schematic diagram of a quantum circuit for solving a system of nonlinear equations according to an embodiment of the present disclosure:

FIG. 4 is a schematic diagram of a quantum circuit corresponding to a quantum linear solver according to an embodiment of the present disclosure:

FIG. 5 is a schematic diagram of a quantum circuit for a walk operator W according to an embodiment of the present disclosure;

FIG. 6 is a quantum circuit diagram for constructing an operator U̅ according to an embodiment of the present disclosure;

FIG. 7 is a schematic diagram of a first sub-quantum circuit module corresponding to phase estimation according to an embodiment:

FIG. 8 is a total quantum circuit diagram corresponding to an HHL algorithm according to an embodiment; and

FIG. 9 is a schematic structural diagram of an apparatus for solving a system of nonlinear equations on the basis of a quantum circuit according to an embodiment.

### DETAIL DESCRIPTION OF THE INVENTION

The technical solutions provided in the embodiments of the present disclosure will be described clearly and completely below with reference to the accompanying drawings in the embodiments of the present disclosure. Apparently, the described embodiments are some, but not all, of the embodiments of the present disclosure. Based on the embodiments of the present disclosure, all the other embodiments obtained by those of ordinary skill in the art without any creative labor fall into the protection scope of the present disclosure.

It should be understood that the terms “first,” “second,” “third,” and “fourth,” and the like in the claims, description, and drawings of the present disclosure are used to distinguish between different objects, and are not used to describe a particular order. The terms “comprise” and “include,” when used in the description and claims of the present disclosure, specify the presence of stated features, integers, steps, operations, elements, and/or components, but do not preclude the presence or addition of one or more other features, integers, steps, operations, elements, components, and/or groups thereof.

It is also to be understood that the terminology used in the description of the present disclosure here is for the purpose of describing particular embodiments only, and is not intended to be limiting of the present disclosure. As used in the specification and claims of the disclosure, the singular forms “a”, “an” and “the” are intended to include the plural forms as well, unless the context clearly indicates otherwise. It should be further understood that the term “and/or” as used in the description and claims of the disclosure refers to any and all possible combinations of one or more of the associated listed items and includes such combinations.

An embodiment of the present disclosure provides a method for solving a system of nonlinear equations on the basis of a quantum circuit, which may be applied to an electronic device such as computer terminals, specifically general computers, quantum computers, or the like. The following detailed description is made by taking the case of running on a computer terminal as an example.

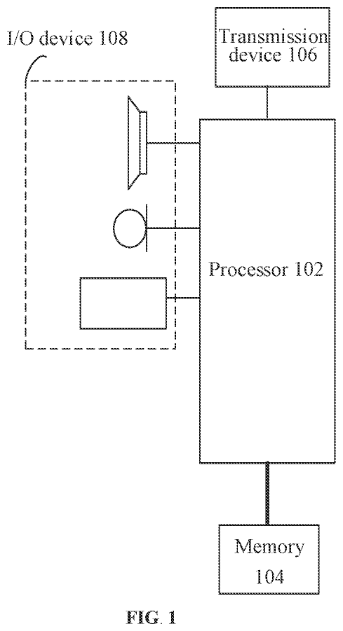

FIG. 1 is a block diagram showing a hardware structure of a computer terminal for solving a system of nonlinear equations on the basis of a quantum circuit according to an embodiment of the present disclosure. As shown in FIG. 1, the computer terminal may include one or more (only one is shown in FIG. 1) processors 102 (which may include, but are not limited to, processing devices such as microprocessors (MCUs) or programmable logic devices (FPGAs)), and a memory 104 used to store data. Optionally, the computer terminal may further include a transmission device 106 for communication functions and an input/output device 108. It will be understood by those ordinary skilled in the art that the structure shown in FIG. 1 is merely illustrative, and does not form any limitation to the structure of the computer terminal. For example, the computer terminal may include more or fewer components than those shown in FIG. 1, or have a different configuration than that shown in FIG. 1.

The memory 104 may be configured to store software programs and modules of application software, such as the program instructions/modules corresponding to the method for solving a system of nonlinear equations on the basis of a quantum circuit provided in the embodiments the present disclosure. The processor 102, by executing the software programs and modules stored on the memory 104, performs various functional applications and data processing, that is, implement the above method. The memory 104 may include a high-speed random access memory, or include a non-volatile memory such as one or more magnetic storage devices, flash memories, or other non-volatile solid state memories. In some examples, the memory 104 may further include a memory remotely disposed relative to the processor 102, which may be connected to the computer terminal via a network. Examples of such networks include, but are not limited to, the Internet, intranets, local area networks, mobile communication networks, and combinations thereof.

The transmission device 106 is configured to receive or transmit data via a network. Specific examples of such networks may include a wireless network provided by a communication provider of the computer terminal. In one example, the transmission device 106 includes a network interface controller (NIC) that may be connected to another network device through a base station to communicate with the internet. In one example, the transmission device 106 may be a radio frequency (RF) module configured to communicate with the internet wirelessly.

It should be noted that, a true quantum computer is a hybrid structure that consists of two major parts: one is a classical computer responsible for classical computation and control; and the other is a quantum device responsible for running a quantum program and thereby implementing quantum computation. The quantum program is a series of instruction sequences written in a quantum language such as QRunes and able to run on a quantum computer, which supports operations of quantum logic gates and finally implements quantum computation. Specifically, the quantum program is a series of instruction sequences that operate quantum logic gates in a certain time sequence.

In practical applications, limited by the development of quantum device hardware, a quantum computation simulation is typically desired to verify a quantum algorithm, a quantum application, or the like. The quantum computation simulation is a process of simulating running of a quantum program corresponding to a specific problem in a virtual architecture (i.e., a quantum virtual machine) built with resources of a general computer. Generally, the quantum program corresponding to the specific problem has to be constructed. The quantum program, as used in the embodiments of the present disclosure, is a program written in a classical language that characterizes qubits and evolution thereof, in which qubits, quantum logic gates, and the like related to quantum computation are represented by corresponding classical codes.

As an embodied form of the quantum program, the quantum circuit, also called quantum logic circuit, is the most commonly used general-purpose quantum computation model that represents a circuit that operates on qubits under an abstract concept. The quantum circuit includes qubits, circuits (timelines), and various quantum logic gates, and results often need to be read out through quantum measurement operations.

Unlike a traditional circuit connected by metal wires and transmitting voltage or current signals, in the quantum circuit, the circuit may be regarded as being connected by time, which means that the state of qubits evolves naturally with time, and in this process, the circuit keeps being operated according to instruction of a Hamiltonian operator until encountering a logic gate.

One quantum program as a whole corresponds to one total quantum circuit, and the quantum program in the present disclosure refers to the total quantum circuit, where the total number of qubits in the total quantum circuit is the same as the total number of qubits in the quantum program. It may be understood as that: one quantum program may be composed of a quantum circuit, measurement operations for qubits in the quantum circuit, a register for saving measurement results, and control flow nodes (jump instructions). One quantum circuit may contain operations of tens, hundreds, or even thousands or ten thousands of quantum logic gates. An execution process of the quantum program is a process of executing all quantum logic gates according to a certain time sequence. It should be noted that the time sequence refers to a time order of a single quantum logic gate to be executed.

It should be noted that the basic unit in the classical computation is bit, the basic control mode is logic gate, and the circuits may be controlled through combinations of logic gates. Similarly, qubits are handled through quantum logic gates. A quantum logic gate may be used to evolve a quantum state. The quantum logic gate is a basis of the quantum circuit, and may include a single-bit quantum logic gate, such as a Hadamard gate (H gate), a Pauli-X gate (X gate), a Pauli-Y gate (Y gate), a Pauli-Z gate (Z gate), an RX gate, an RY gate, an RZ gate, or the like; or a multi-bit quantum logic gate, such as a CNOT gate, a CR gate, an iSWAP gate, a Toffoli gate, or the like. The quantum logic gate is generally represented in a unitary matrix, which is not only in a matrix form, but also a kind of operation and transformation. Generally, the effect of the quantum logic gate on the quantum state is calculated by multiplying a left side of the unitary matrix by a matrix corresponding to a right vector of the quantum state.

The quantum state, i.e., a logical state of the qubit, is expressed in binary in the quantum algorithm (or quantum program). For example, a group of qubits is q0, q1, and q2, representing the 0^{th}, 1^{st}, and 2^{nd} qubits, which are ranked as q2q1q0 from high to low. The quantum state corresponding to this group of qubits is a superposition of eigenstates corresponding to the qubits in the group. The number of eigenstates corresponding to this group of qubits is 2 to the power of the total number of qubits, that is, 8 eigenstates (determined states): |000>, |001>, |010>, |011>, |100>, |101>, |110>, |111>, each having bits corresponding to the qubits, such as a |000> state, 000, corresponding to q2q1q0 from high to low, where |> is the Dirac symbol.

Taking a single qubit as an example for illustration, the logical state φ of the single qubit may be in a |0 [symbol] state, a |1 [symbol] state, and a superposition state (uncertain state) of a |0> state and a |1> state, which may be specifically expressed as φ=c|0 [symbol] +d|1 [symbol] , where c and d are complex numbers each representing a quantum state amplitude (probability amplitude), and squares of the amplitude modulus |c|² and |d|² respectively represent the probabilities of |0> state and |1> state, where |c|²+|d|²=1. In short, the quantum state is a superposition state of various eigenstates, and when the probability of other eigenstates is 0, it is in the only definite eigenstate.

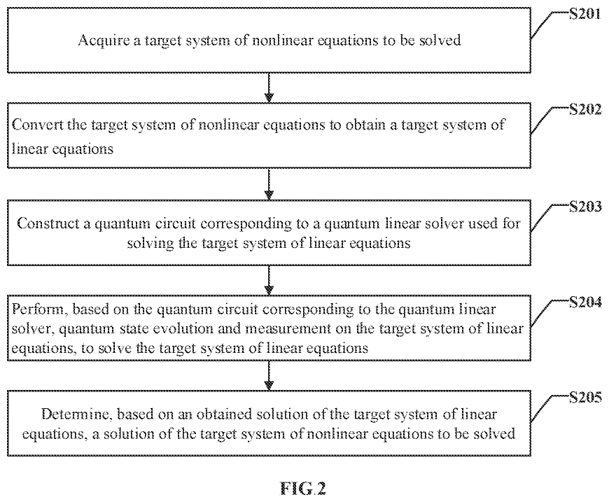

FIG. 2 is a schematic flowchart of a method for solving a system of nonlinear equations on the basis of a quantum circuit according to an embodiment of the present disclosure. As shown in FIG. 2, the method may include the following steps S201 to S205.

At S201: a target system of nonlinear equations to be solved is acquired. In one embodiment, the target system of nonlinear equations to be solved may include a system of quadratic nonlinear equations or a system of nonlinear ordinary differential equations.

It may be understood that nonlinear problems are very common in nature, such as nonlinear finite element analysis, nonlinear dynamics, nonlinear programming, and the like, and therefore, it is important to construct an algorithm for solving nonlinear problems.

The nonlinear equation is named after a nonlinear relationship between a dependent variable and an independent variable, and is an extension of mathematics after the emergence of various practical problems and the establishment of equations based on problems in real life. The nonlinear equation has gained more and more attentions of people, and become an important research direction of modern mathematics.

The nonlinear equation provides key theoretical support and plays an important role in many fields of science and technology, such as in the fields of mechanics, economics, biotechnology, electronics, and the like. An accurate solution of such equations is hard to obtained, and thus, an approximate solution is usually desired, and corresponding methods for obtaining approximate solutions have gradually gained wide attention. As an important component of nonlinear equations, the system of quadratic nonlinear equations is of great significance both in theory and practice.

In addition, the ordinary differential equation (ODE), a differential equation whose unknown function contains only one independent variable, is gradually developed with calculus, and is an extension of mathematics after the emergence of various practical problems and the establishment of equations based on problems in real life. The ordinary differential equation has gained more and more attentions of people, and become an important research direction of modern mathematics. Similarly, the ordinary differential equation provides key theoretical support and plays an important role in many fields of science and technology, such as in the fields of mechanics, economics, biotechnology, electronics, and the like. These practical problems are finally converted into either obtaining a solution of a differential equation, or studying properties of a solution corresponding to the equation. Most problems in real life can be transformed into obtaining a special solution of a differential equation that satisfies given initial boundary value conditions.

As an important component of ordinary differential equations, the nonlinear dissipative system of ordinary differential equations is of great significance both in theory and practice. The system of nonlinear dissipative ordinary differential equations is far more complex than the system of linear ordinary differential equations, making it almost impossible to solve the system of nonlinear ordinary differential equations in an elementary integral method. Therefore, a method different from that of the linear differential equation theory has to be used to study a solution of a system of nonlinear ordinary differential equations.

In one embodiment, the system of quadratic nonlinear equations may be expressed as:

$${F}_{0} + {F}_{1} x + {F}_{2} {x}^{⊗ {}_{2}} = 0$$

where x∈Rⁿ, R represents real number space, Fᵢ∈Rⁿ×Rⁿ^{ⁱ}, and F₁ and F₂ each have a sparsity s.

Exemplarily, it is assumed that the system of quadratic nonlinear equations is:

$$\{ \begin{matrix}3 {x}_{0} - {x}_{1} - 0.5 {x}_{0}^{2} + 0.5 {x}_{0} {x}_{1} + 0.2 = 0 \\ - {x}_{0} + 3 {x}_{1} - 0.5 {x}_{1}^{2} + 0.5 {x}_{1} {x}_{0} - 0.2 = 0\end{matrix}$$

then the corresponding F₀, F₁, F₂ are respectively:

$${F}_{0} = ( \begin{matrix}0.2 \\ - 0.2\end{matrix} ) , {F}_{1} = ( \begin{matrix}3 & - 1 \\ - 1 & 3\end{matrix} ) , and {F}_{2} = ( \begin{matrix}- 0.5 & 0.5 & 0 & 0 \\ 0 & 0 & 0.5 & - 0.5\end{matrix} ) .$$

Give Oracles O_{F}_{₁} and O_{F}_{₂} of non-zero element positions and non-zero element values obtained by querying F₁ and F₂:

$${O}_{{F}_{11}} \vert j 〉 \vert 0 〉 = \vert j 〉 \vert {f}_{1} ( j , k ) 〉 , 0 \leq j \leq n - 1 , 0 \leq k \leq s - 1 {O}_{{F}_{12}} \vert j 〉 \vert k 〉 \vert z 〉 = \vert j 〉 \vert k 〉 \vert {F}_{1 j , k} 〉 , 0 \leq j , k \leq n - 1 \\ {O}_{{F}_{21}} \vert j 〉 \vert 0 〉 = \vert j 〉 \vert {f}_{2} ( j , k ) 〉 , 0 \leq j \leq n - 1 , 0 \leq k \leq s - 1 \\ {O}_{{F}_{22}} \vert j 〉 \vert k 〉 \vert z 〉 = \vert j 〉 \vert k 〉 \vert {F}_{2 j , k} 〉 , 0 \leq j \leq n - 1 , 0 \leq j \leq {n}^{2} - 1$$

Give an Oracle O_{F}_{₀} for preparing F₀, which implements the function of:

$${O}_{{F}_{0}} \vert 0 〉 = \frac{1}{‖ {F}_{0} ‖} {\sum }_{j = 1}^{n - 1} {F}_{0 , i} \vert i 〉$$

In another embodiment, the system of nonlinear ordinary differential equations may be expressed as:

$$\frac{d u}{d t} = {F}_{1}^{′} u + {F}_{2}^{′} {u}^{{⊗}_{2}} , u ( 0 ) = {u}_{in}$$

where u is a function to be solved of the system of nonlinear ordinary differential equations, u∈ [symbol] ⁿ, [symbol] is real number space, and F₁′ and F₂′ are sparse matrices independent of time with a sparsity s, F₁′∈ [symbol] ^{n×n}, and F₂′∈ [symbol] ^{n×n}^{²}, that is, the number of non-zero elements in each row or column of F₁′ and F₂′ does not exceed s. Assuming that F₁′ is a normal matrix, where D=diag (λ₁, λ₂, . . . , λₙ) and eigenvalues of F₁′ satisfy Re(λₙ)≤ . . . ≤Re(λ₁)<0, given preset parameters O_{F}_{₁}′, O_{F}_{₂}′ and Oᵤ, O_{F}_{₁}′ and O_{F}_{₂}′ are respectively used to extract non-zero positions and values of F₁′ and F₂′, Oᵤ is used to solve |uᵢₙ), and O_{F}_{₁}′, O_{F}_{₂}′ and Oᵤ are defined as:

$${O}_{{F}_{11}^{′}} \vert j 〉 \vert 0 〉 = \vert j 〉 \vert {f}_{1} ( j , k ) 〉 , 0 \leq j \leq n - 1 , 0 \leq k \leq s - 1 ; {O}_{{F}_{12}^{′}} \vert j 〉 \vert k 〉 \vert z 〉 = \vert j 〉 \vert k 〉 \vert {F}_{1 j , k} 〉 , 0 \leq j , k \leq n - 1 ; \\ {O}_{{F}_{13}^{′}} \vert j 〉 \vert 0 〉 = \vert j 〉 \vert g ( j ) 〉 , 0 \leq j \leq n - 1 ; \\ {O}_{{F}_{21}^{′}} \vert j 〉 \vert k 〉 = \vert j 〉 \vert {f}_{2} ( j , k ) 〉 , 0 \leq j \leq n - 1 , 0 \leq k \leq s - 1 ; \\ {O}_{{F}_{22}^{′}} \vert j 〉 \vert k 〉 \vert z 〉 = \vert j 〉 \vert k 〉 \vert {F}_{2 j , k} 〉 , 0 \leq j \leq n - 1 , 0 \leq j \leq {n}^{2} - 1 ; and \\ {O}_{u} \vert 0 〉 = \vert {u}_{in} / ‖ {u}_{in} ‖ 〉 ,$$

where f₁(j,k) and f₂(j,k) respectively represent column numbers of a k^{th} non-zero element in row j of F₁′ and F₂′, g(j) satisfies f₁(j,g(j))=j, and a diagonal element of F₁′ is regarded as a non-zero element. A preset matrix (Oracle) related to F₁′ is constructed with O_{F}_{₁₃}′, and a parameter R is defined to limit

$$\frac{d u}{d t} = {F}_{1}^{′} u + {F}_{2}^{′} {u}^{{⊗}_{2}} , u ( 0 ) = {u}_{in} ,$$

which is specifically expressed as:

$$R := \frac{4 ‖ {u}_{in} ‖ ‖ {F}_{2}^{′} ‖}{\vert Re ( {λ}_{1} ) \vert}$$

Given R≤∥uᵢₙ∥, if not satisfied, a suitable constant may be used to scale u to ζu, so that R≤∥uᵢₙ∥.

At S202: the target system of nonlinear equations to be solved is converted to obtain a target system of linear equations.

In one embodiment, in the case where the target system of nonlinear equations is a system of quadratic nonlinear equations, the system of quadratic nonlinear equations may be converted into a preset system of pseudo-linear equations according to a homotopy perturbation method, and then the preset system of pseudo-linear equations may be converted into a target system of quadratic linear equations in a linear embedding method.

In another embodiment, in the case where the target system of nonlinear equations is a system of nonlinear ordinary differential equations, the system of nonlinear ordinary differential equations may be converted into a preset type of system of nonlinear ordinary differential equations in a homotopy perturbation method, and thus the preset type of system of nonlinear ordinary differential equations may be converted into a target system of linear ordinary differential equations in a linear embedding method.

It may be understood that the homotopy perturbation method is a method that combines the homotopy theory and the perturbation technique, which, differs from the traditional perturbation theory that depends on small parameters, constructs an equation containing embedded parameters by the homotopy technique, and then takes the embedded parameters as small parameters. Therefore, this method not only overcomes shortcomings of the traditional perturbation theory, but also makes full use of various perturbation methods. The essence of the homotopy perturbation method is to transform the nonlinear problem into an infinite number of linear problems to deal with. In this method, an approximate solution of an equation may be written as an addition of a series of infinite series, and this series sum converges to an exact solution thereof. A large number of examples has shown that this method is simple and effective, and a resulting first order approximation solution is often of high accuracy. It should be said that the homotopy perturbation method is a very common method for solving nonlinear problems.

In an implementation scenario, when the target system of nonlinear equations is a system of quadratic nonlinear equations, the system of quadratic nonlinear equations F₀+F₁x+F₂x^{⊗}^{²}=0 is converted into a preset system of pseudo-linear equations related to a series of v₀, v₁, . . . , v_{c} according to the homotopy perturbation method.

First, a homotopy H is constructed: Rⁿ×[0,1]→Rⁿ, H(v,p)=F₀+F₁v+F₂v^{⊗}^{²}=0, assuming that a solution of H(v,p)=0 is expressed as: v=v₀+pv₁+p²v₂+ . . . +p^{c}v_{c}, it can be obtained by substitution that:

$${F}_{1} {v}_{0} + {F}_{0} = 0 \\ {F}_{1} {v}_{1} + {F}_{2} ( {v}_{0} ⊗ {v}_{0} ) = 0 \\ {F}_{1} {v}_{2} + {F}_{2} ( {v}_{0} ⊗ {v}_{1} + {v}_{1} ⊗ {v}_{0} ) = 0 \\ … \\ {F}_{1} {v}_{c} + {F}_{2} {\sum }_{j = 0}^{j = c - 1} {v}_{j} ⊗ {v}_{c - 1 - j} = 0$$

Assuming F₁ is invertible, the preset system of pseudo-linear equations is:

$${v}_{0} = - {F}_{1}^{- 1} {F}_{0} \\ {v}_{1} = - {F}_{1}^{- 1} {F}_{2} ( {v}_{0} ⊗ {v}_{0} ) \\ {v}_{2} = - {F}_{1}^{- 1} {F}_{2} ( {v}_{0} ⊗ {v}_{1} + {v}_{1} ⊗ {v}_{0} ) \\ … \\ {v}_{c} = - {F}_{1}^{- 1} {F}_{2} {\sum }_{j = 0}^{j = c - 1} {v}_{j} ⊗ {v}_{c - 1 - j}$$

where vᵢ is a variable to be solved in the preset system of pseudo-linear equations, 0≤i≤c, and the c is the number of variables to be solved in the preset system of pseudo-linear equations.

When p=1, we can get: \tilde{x}=v₀+v₁+ . . . +v_{c}.

Based on the converted preset system of pseudo-linear equations, the preset system of pseudo-linear equations is then converted into a target system of quadratic linear equations in a linear embedding method.

Specifically, the equation F₀+F₁x+F₂x^{⊗}^{²}=0 is converted into a preset system of pseudo-linear equations taking v₀, v₁, . . . , v_{c} as the variables to be solved according to the homotopy perturbation method. Then, the system of pseudo-linear equations taking v₀, v₁, . . . , v_{c} as the variables to be solved is embedded into a larger linear system. In other words, the equations are embedded into a higher dimension linear system:

Ay=b

where y=y₀, y₁, . . . , y_{c}, yᵢ satisfies:

$${y}_{0} = {v}_{0} + {v}_{1} + {v}_{2} + … + {v}_{c} \\ {y}_{i} = [ {y}_{i , 0} , {y}_{i , 1} , {y}_{i , 2} , … , {y}_{i , {β}_{i} - 1} ]$$

where βᵢ represents the number of items in yᵢ. A value of βᵢ is inferred from the expression of y_{i,j}, y_{i,j} is written as:

y_{i,j}=⊗ₖ₌₀ⁱvₐ_{_{i,j,k}}, and a_{i,j,k} satisfies a_{i,j,k}≥0, and i+1≤Σₖ₌₀ⁱa_{i,j,k}+1≤c+1. Therefore, it is inferred that yᵢ contains

$${\sum }_{k = i}^{c} ( \begin{matrix}k \\ i\end{matrix} )$$

items in total, and βᵢ may be expressed as:

$${β}_{i} = \{ \begin{matrix}1 , i = 0 \\ {\sum }_{k = i}^{c} ( \begin{matrix}k \\ i\end{matrix} ) , 1 \leq i \leq c\end{matrix}$$

Defining \vec{a}_{i,j}=[a_{i,j,0}, a_{i,j,1}, . . . , a_{i,j,i}], where \vec{a}_{i,j} corresponds to j one by one, so the following two operations can be constructed:

$${0}_{{a}_{1}} \vert {\vec{a}}_{i , j} 〉 \vert 0 〉 = \vert {\vec{a}}_{i , j} 〉 \vert j 〉 \\ {0}_{{a}_{2}} \vert j 〉 \vert 0 〉 = \vert j 〉 \vert {\vec{a}}_{i , j} 〉$$

Oₐ_{₁} and Oₐ_{₂} may be implemented with quantum arithmetic of a O(c) bit quantum circuit with a gate complexity O(ploy(c)).

For y_{i,j}=vₐ_{_{i,j,0}}⊗vₐ_{_{i,j,1}}⊗ . . . ⊗vₐ_{_{i,j,i}}, when \vec{a}_{i,j} contains a value greater than 0, assuming that a first value greater than 0 is a_{i,j,k}, then

$${I}_{n}^{⊗ {}_{k}} ⊗ {F}_{1} ⊗ {I}_{n}^{⊗ {}_{i - k}} ) {y}_{i , j} + {v}_{{a}_{i , j , 0}} ⊗ … ⊗ {v}_{{a}_{i , j , k - 1}} ⊗ {F}_{2} ( {\sum }_{1 - 0}^{{a}_{i , j , k} - 1} {v}_{1} ⊗ {v}_{{a}_{i , j , k}} - 1 - 1 ) ⊗ … ⊗ {v}_{{a}_{i , j , i}} = 0$$

where vₐ_{_{i,j,0}}⊗ . . . ⊗vₗ⊗vₐ_{_{i,j,k}}−1−l⊗ . . . ⊗vₐ_{_{i,j,i}}∈yᵢ₊₁, and if we take y_{i,0}=v₀^{⊗i+1}, then: F₁^{⊗i+1}y_{i,0}=(−F₀)^{⊗i+1}.

From the above equations, we obtain bᵢ=[−F₀)^{⊗+1}, 0, . . . , 0], and the final equation Ay=b may be expanded as:

$$[ \begin{matrix}{A}_{0 , 0} & {A}_{0 , 1} & 0 & 0 & 0 & 0 \\ 0 & {A}_{1 , 1} & {A}_{1 , 2} & 0 & 0 & 0 \\ 0 & 0 & {A}_{2 , 2} & ⋱ & 0 & 0 \\ 0 & 0 & 0 & ⋱ & {A}_{c - 1 , c - 2} & 0 \\ 0 & 0 & 0 & 0 & {A}_{c - 1 , c - 1} & {A}_{c - 1 , c} \\ 0 & 0 & 0 & 0 & 0 & {A}_{c , c}\end{matrix} ] [ \begin{matrix}{y}_{0} \\ {y}_{1} \\ {y}_{2} \\ ⋮ \\ {y}_{c - 1} \\ {y}_{c}\end{matrix} ] = [ \begin{matrix}{b}_{0} \\ {b}_{1} \\ {b}_{2} \\ ⋮ \\ {b}_{c - 1} \\ {b}_{c}\end{matrix} ]$$

where A_{i,i} is a

$${n}^{i + 1} {\sum }_{j = i}^{c} ( \begin{matrix}j \\ i\end{matrix} ) \times {n}^{i + 1} {\sum }_{j = i}^{c} ( \begin{matrix}j \\ i\end{matrix} )$$

dimension matrix, A_{i,i+1} is a nⁱ⁺¹βᵢ×nⁱ⁺²βᵢ₊₁ dimension matrix, y=y₀, y₁, . . . , y_{c}, yᵢ satisfies y₀=v₀+v₁+v₂+ . . . +v_{c}, yᵢ=[y_{i,0}, y_{i,1}, y_{i,2}, . . . , y_{i,β}_{ᵢ}₋₁], and βᵢ represents the number of items in yᵢ.

To optimize the linear system Ay=b, it can be seen from the above equation that A contains a block matrix F₁^{⊗i}, i=1, . . . , c, which makes the condition number of A increase with a c exponent, so F₁^{⊗i+1}y_{i,0}=(−F₀)^{⊗i+1} is split into:

$$[ \begin{matrix}{F}_{1} ⊗ {I}_{n}^{⊗ {}_{i}} & I & & 0 \\ 0 & {I}_{n} ⊗ {F}_{1} ⊗ {I}_{n}^{⊗ {}_{i - 1}} & I & 0 \\ ⋮ & 0 ⋱ & & ⋮ \\ 0 & … & & {I}_{n}^{⊗ {}_{i}} ⊗ {F}_{1}\end{matrix} ] [ \begin{matrix}{v}_{0}^{⊗ {}_{i + 1}} \\ {F}_{0} ⊗ {v}_{0}^{⊗ {}_{i}} \\ ⋮ \\ {F}_{0}^{⊗ {}_{i - 1}} ⊗ {v}_{0}^{⊗ {}_{2}} \\ {F}_{0}^{⊗ {}_{i}} ⊗ {v}_{0}\end{matrix} ] = [ \begin{matrix}0 \\ 0 \\ ⋮ \\ 0 \\ - {F}_{0}^{⊗ {}_{i + 1}}\end{matrix} ]$$

The split linear system has a better condition number and redefines y_{i,0} as:

$${y}_{i , 0} = [ {v}_{0}^{⊗ {}_{i + 1}} , {F}_{0} ⊗ {v}_{0}^{⊗ {}_{i}} , … , {F}_{0}^{⊗ {}_{i}} ⊗ {v}_{0} ]$$

Continue with the above example, if we take c=2, then components of the optimized y are written as:

$$\begin{matrix}{y}_{0} = [ {v}_{0} + {v}_{1} + {v}_{2} ] \\ {y}_{1} = [ {v}_{0} ⊗ {v}_{0} , {F}_{0} ⊗ {v}_{0} , {v}_{0} ⊗ {v}_{1} , {v}_{1} ⊗ {v}_{0} ] \\ {y}_{2} = [ {v}_{0}^{⊗ {}_{3}} , {F}_{0} ⊗ {v}_{0} ⊗ {v}_{0} , {F}_{0} ⊗ {F}_{0} ⊗ {v}_{0} ]\end{matrix}$$

The corresponding matrix A may be written as:

$$( \begin{matrix}{F}_{1} & {F}_{2} & 0 & {F}_{2} & {F}_{2} & 0 & 0 & 0 \\ 0 & {F}_{1} ⊗ {I}_{2} & {I}_{4} & 0 & 0 & 0 & 0 & 0 \\ 0 & 0 & {I}_{2} ⊗ {F}_{1} & 0 & 0 & 0 & 0 & 0 \\ 0 & 0 & 0 & {I}_{2} ⊗ {F}_{1} & 0 & {I}_{2} ⊗ {F}_{2} & 0 & 0 \\ 0 & 0 & 0 & 0 & {F}_{1} ⊗ {I}_{2} & {F}_{2} ⊗ {I}_{2} & 0 & 0 \\ 0 & 0 & 0 & 0 & 0 & {F}_{1} ⊗ {I}_{4} & {I}_{8} & 0 \\ 0 & 0 & 0 & 0 & 0 & 0 & {I}_{2} ⊗ {F}_{1} ⊗ {I}_{2} & {I}_{8} \\ 0 & 0 & 0 & 0 & 0 & 0 & 0 & {I}_{4} ⊗ {F}_{1}\end{matrix} )$$

$$b = {[ - {F}_{0} , {0}_{4} , - {F}_{0}^{⊗ {}_{2}} , {0}_{4} , {0}_{4} , {0}_{8} , {0}_{8} , - {F}_{0}^{⊗ {}_{3}} ]}^{T} ,$$

where 0₄=[0,0,0,0], and 0₈ is similar to 0₄.

The linear system Ay=b is also adjusted accordingly. In the following, the Ay=b is default as the optimized linear system, and the optimized matrix A has a dimension number of:

$$N = {\sum }_{i = 0}^{c} {n}^{i + 1} ( {β}_{i} + i ) = {( n + 1 )}^{c + 1} - 1 - s n + \frac{{cn}^{c} ( n - 1 ) - {n}^{c} + 1}{{( n + 1 )}^{2}} {n}^{2} \approx {( n + 1 )}^{c + 1} + {cn}^{c + 1} .$$

For the condition number of the matrix A, some lemmas are given as follows:

Lemma 1: given an n dimension invertible matrix M and i∈ [symbol] ⁺, and a new matrix is defined:

$$P = [ \begin{matrix}M ⊗ {I}_{n}^{⊗ {}_{i}} & I & & 0 \\ 0 & {I}_{n} ⊗ M ⊗ {I}_{n}^{⊗ {}_{i - 1}} & I & 0 \\ ⋮ & 0 ⋱ & & ⋮ \\ 0 & … & & {I}_{n}^{⊗ {}_{i}} ⊗ M\end{matrix} ]$$

then P is invertible and satisfies

$$‖ {P}^{- 1} ‖ \leq \frac{‖ {M}^{- 1} ‖ ( 1 - {‖ {M}^{- 1} ‖}^{i + 1} )}{1 - ‖ {M}^{- 1} ‖}$$

Lemma 2: ∥A∥ satisfies ∥A∥≤∥F₁∥+1+(c+1)∥F₂∥.

Lemma 3: given the optimized linear system Ay=b, a truncation order c, when F₁, F₂ satisfy: |F₁-1|<1, and

$$\frac{‖ {F}_{1}^{- 1} ‖}{1 - ‖ {F}_{1}^{- 1} ‖} ( c + 1 ) ‖ {F}_{2} ‖ < 1 , {A}^{- 1}$$

satisfies:

$$‖ {A}^{- 1} ‖ \leq \frac{‖ {F}_{1}^{- 1} ‖}{1 - ‖ {F}_{1}^{- 1} ‖ ( 1 + ( c + 1 ) ‖ {F}_{2} ‖ )}$$

Therefore, for a given optimized linear system Ay=b and truncation order c, when F₁, F₂ satisfy:

$$‖ {F}_{1}^{- 1} ‖ < 1 , and \frac{‖ {F}_{1}^{- 1} ‖}{1 - ‖ {F}_{1}^{- 1} ‖} ( c + 1 ) ‖ {F}_{2} ‖ < 1 ,$$

the condition number κ(A) of the matrix A satisfies:

$$κ ( A ) \leq \frac{κ ( {F}_{1} ) + 1}{1 - ‖ {F}_{1}^{- 1} ‖ ( 1 + ( c + 1 ) ‖ {F}_{2} ‖ )}$$

In another implementation scenario, when the target system of nonlinear equations is a system of nonlinear ordinary differential equations, the system of nonlinear ordinary differential equations is converted into a preset type of system of nonlinear ordinary differential equations in a homotopy perturbation method.

Exemplarily, a homotopy v(t,p): [symbol] ⁿ×[0,1]→ [symbol] ⁿ is constructed in the homotopy perturbation method, which satisfies:

$$H ( v , p ) = \frac{dv}{dt} - {F}_{1}^{′} v - p {F}_{2}^{′} {v}^{{⊗}_{2}} = 0 , v ( 0 , p ) = {u}_{i n}$$

Assuming that v is expressed as: v=v₀+pv₁+p²v₂+ . . . +p^{c}v_{c}, items with the same power of p are equivalent to obtain the preset type of system of nonlinear ordinary differential equations converted from

$$\frac{du}{dt} = {F}_{1}^{′} u + {F}_{2}^{′} {u}^{{⊗}_{2}} , u ( 0 ) = {u}_{i n} ,$$

which is specifically:

$$\frac{{dv}_{0}}{dt} - {F}_{1}^{′} {v}_{0} = 0 , {v}_{0} ( 0 ) = {u}_{i n}$$

$$\frac{{dv}_{1}}{dt} - {F}_{1}^{′} {v}_{1} - {F}_{2}^{′} {v}_{0} ⊗ {v}_{0} = 0 , {v}_{1} ( 0 ) = 0$$

$$\frac{{dv}_{2}}{dt} - {F}_{1}^{′} {v}_{2} - {F}_{2}^{′} ( {v}_{0} ⊗ {v}_{1} + {v}_{1} ⊗ {v}_{0} ) = 0 , {v}_{2} ( 0 ) = 0$$

$$…$$

$$\frac{{dv}_{c}}{dt} - {F}_{1}^{′} {v}_{c} - {F}_{2}^{′} {\sum }_{j = 0}^{c - 1} {v}_{j} ⊗ {v}_{c - 1 - j} = 0 , {v}_{c} ( 0 ) = 0$$

where the c is the number of functions to be solved in the preset type of system of nonlinear ordinary differential equations, and vᵢ is a function to be solved of the preset type of system of nonlinear ordinary differential equations, and 0≤i≤c. The preset type of system of nonlinear ordinary differential equations is a series of ordinary differential equations with nonlinear variables vᵢ.

When p=1, ũ=v₀+v₁+v₂+ . . . +v_{c}.

Based on the converted preset type of system of nonlinear ordinary differential equations, the preset type of system of nonlinear ordinary differential equations may be converted into a target system of linear ordinary differential equations in a linear embedding method.

Specifically, the preset type of system of nonlinear ordinary differential equations is embedded into a system of linear ordinary differential equations with y as the viable, i.e., a target system of linear ordinary differential equations in a linear embedding method:

$$\frac{d \vec{y}}{dt} = A \vec{y} , \vec{y} ( 0 ) = {y}_{i n}$$

where \vec{y}=[\vec{y}₀, \vec{y}₁, \vec{y}₂, . . . , \vec{y}_{c}], and \vec{y}ᵢ satisfies:

$$\vec{y} = \{ \begin{matrix}[ {v}_{0} + {v}_{1} + {v}_{2} + … + {v}_{c} ] , i = 0 \\ [ {\vec{y}}_{i , 0} , {\vec{y}}_{i , 1} , {\vec{y}}_{i , 2} , … , {\vec{y}}_{i , {β}_{i} - 1} ] , 1 \leq i \leq c\end{matrix}$$

βᵢ represents the number of items in \vec{y}ᵢ, \vec{y}_{i,j} represents a j^{th} item in \vec{y}ᵢ, expressed as \vec{y}_{i,j}=⊗ₖ₌₀ⁱvₐ_{_{i,j,k}}, and a_{i,j,k} satisfies: a_{i,j,k}≥0, and i+1≤Σₖ₌₀ⁱa_{i,j,k}+1≤c+1.

βᵢ satisfies:

$${β}_{i} = \{ \begin{matrix}1 , i = 0 \\ {\sum }_{k = 1}^{c} ( \begin{matrix}k \\ i\end{matrix} ) , 1 \leq i \leq c\end{matrix}$$

yᵢₙ may be written as:

$${y}_{i n} = [ [ {u}_{i n} ] , [ {u}_{i n}^{⊗ 2} , 0 , … , 0 ] [ {u}_{i n}^{⊗ 3} , 0 , … , 0 ] [ {u}_{i n}^{⊗ c} ] ]$$

Define \vec{a}_{i,j}=[a_{i,j,0}, a_{i,j,1}, . . . , a_{i,j,i}] and construct two Oracles:

$${O}_{{a}_{1}} \vert {\vec{a}}_{i , j} 〉 \vert 0 〉 = \vert {\vec{a}}_{i , j} 〉 \vert j 〉$$

$${O}_{{a}_{2}} \vert j 〉 \vert 0 〉 = \vert j 〉 \vert {\vec{a}}_{i , j} 〉$$

the dimension number of \vec{y}ᵢ is nⁱ⁺¹βᵢ, so the dimension number N of [symbol] is:

$$N = {\sum }_{i = 0}^{c} {n}^{i + 1} {β}_{i} = {( n + 1 )}^{c + 1} - 1 - cn \approx {( n + 1 )}^{c + 1} .$$

For initial state preparation of |yᵢₙ [symbol] , we can firstly define:

$$\vert {y}_{i n} 〉 = \frac{1}{\sqrt{M}} {\sum }_{i = 0}^{c} \vert i , 0 〉 \vert {u}_{i n}^{{⊗}_{i + 1}} 〉$$

where M=Σⱼ₌ᵢ^{c}∥uᵢₙ∥²⁽ⁱ⁺¹⁾, and given the Oᵤ|0 [symbol] =|uᵢₙ/∥uᵢₙ∥ [symbol] defined above, |yᵢₙ [symbol] may be prepared by querying a frequency of OᵤO(c).

Specifically,

$$\vert Ψ 〉 = \frac{1}{\sqrt{M}} {\sum }_{i = 0}^{c} {‖ {u}_{i n} ‖}^{2 ( i + 1 )} \vert i , 0 〉$$

is firstly prepared, then a controlled Oᵤ operation

$$C - {O}_{u} = \frac{1}{\sqrt{M}} {\sum }_{i = 0}^{c} \vert i , 0 〉 〈 i , 0 \vert ⊗ {O}_{u}^{{⊗}_{i = 1}}$$

is performed to obtain the above initial state of |yᵢₙ [symbol] .

Finally, after constructing the preset matrices (Oracles) of A_{i,i} and A_{i,i+1}, the preset matrix (Oracle) of A can be directly constructed by querying the preset matrices (Oracles) of A_{i,i} and A_{i,i+1} once. Therefore, the preset matrix (Oracle) OA may be constructed by querying O_{F}_{₁}O(c) and O_{F}_{₂}O(1) frequencies.

Exemplarily,

$$\frac{d \vec{y}}{dt} = A \vec{y} , \vec{y} ( 0 ) = {y}_{i n}$$

is solved with a quantum algorithm, and \vec{y}(t) is written into:

$$\vec{y} ( t ) = {e}^{A t} \vec{y} ( 0 ) ,$$

define:

$${T}_{k} ( z ) := {\sum }_{j = 0}^{k} \frac{{z}^{j}}{j !} .$$

When k is large enough and the evolution time h is short (for example, h≤1/∥A∥), \vec{y}(h)≈Tₖ(Ah)\vec{y}(0), and this approximate solution may be used as an initial condition for a next approximation. This process is repeated for m steps, and then the approximation of \vec{y}(mh) can be obtained.

Let m, k, p∈ [symbol] +, and define:

$${C}_{m , k , p} ( A ) := {\sum }_{j = 0}^{d} \vert j 〉 〈 j \vert ⊗ I - {\sum }_{i = 0}^{m - 1} {\sum }_{j = 1}^{k} \vert i ( k + 1 ) + j 〉 〈 i ( k + 1 ) + j - 1 \vert ⊗ \frac{A}{j} - {\sum }_{i = 0}^{m - 1} {\sum }_{j = 0}^{k} \vert ( i + 1 ) ( k + 1 ) + j 〉 〈 i ( k + 1 ) + j \vert ⊗ I - {\sum }_{j = d - p + 1}^{d} \vert j 〉 〈 j - 1 \vert ⊗ I ,$$

where d: =m(k+1)+p.

Considering the linear system: C_{m,k,p}(Ah)|x [symbol] =|0 [symbol] |yᵢₙ [symbol] where |yᵢₙ [symbol] ∈ [symbol] ⁿ, h∈ [symbol] ⁺, after evolution, an approximate solution of k order Taylor series is obtained, and the solution at a p^{th} order remain unchanged. In this case, a solution of C_{m,k,p}(Ah)|x [symbol] =|0 [symbol] |yᵢₙ [symbol] is expressed as: |x [symbol] =C_{m,k,p}(Ah)⁻¹|0 [symbol] |yᵢₙ [symbol] , or may be written as:

$$\vert x 〉 = {\sum }_{i = 0}^{m - 1} {\sum }_{j = 0}^{k} \vert i ( k + 1 ) + j 〉 \vert {x}_{i , j} 〉 + {\sum }_{j = 0}^{p} \vert m ( k + 1 ) + j 〉 \vert {x}_{m , j} 〉$$

$$and$$

$$\vert {y}_{i n} 〉$$

$$satisfies :$$

$$\vert {x}_{0 , 0} 〉 = \vert {y}_{i n} 〉$$

$$\vert {x}_{i , 0} 〉 = {\sum }_{j = 0}^{k} \vert {x}_{i - 1 , f} 〉 , 0 \leq i \leq m$$

$$\vert {x}_{i , 1} 〉 = Ah \vert {x}_{i , 0} 〉 , 0 \leq i \leq m$$

$$\vert {x}_{i , j} 〉 = ( \frac{Ah}{j} ) \vert {x}_{i - 1 , j} 〉 , 0 \leq i \leq m , 2 \leq j \leq k$$

$$\vert {x}_{m , j} 〉 = \vert {x}_{m , j - 1} 〉 , 1 \leq j \leq p$$

$$Then :$$

$$\vert {x}_{0 , 0} 〉 = \vert {y}_{i n} 〉$$

$$\vert {x}_{0 , j} 〉 = ( {( Ah )}^{j} / j ! ) \vert {x}_{0 , 0} 〉 , 1 \leq j \leq k$$

$$\vert {x}_{1 , 0} 〉 = {T}_{k} ( Ah ) \vert {x}_{0 , 0} 〉 \approx exp ( Ah ) \vert {y}_{i n} 〉$$

$$\vert {x}_{1 , j} 〉 = ( {( Ah )}^{j} / j ! ) \vert {x}_{1 , 0} 〉 , 1 \leq j \leq k$$

$$\vert {x}_{2 , 0} 〉 = {T}_{k} ( Ah ) \vert {x}_{1 , 0} 〉 \approx exp ( 2 Ah ) \vert {y}_{i n} 〉$$

$$⋮$$

$$\vert {x}_{m - 1 , 0} 〉 = {T}_{k} ( Ah ) \vert {x}_{m - 2 , 0} 〉 \approx exp ( Ah ( m - 1 ) ) \vert {y}_{i n} 〉$$

$$\vert {x}_{m - 1 , j} 〉 = ( {( Ah )}^{j} / j ! ) \vert {x}_{m - 1 , 0} 〉 , 1 \leq j \leq k$$

$$\vert {x}_{m , 0} 〉 = {T}_{k} ( Ah ) \vert {x}_{m - 1 , 0} 〉 \approx exp ( 2 Ahm ) \vert {y}_{i n} 〉$$

$$\vert {x}_{m , j} 〉 = \vert {x}_{m , 0} 〉 \approx exp ( Ahm ) \vert {y}_{i n} 〉 , 1 \leq j \leq p$$

|x_{i,0} [symbol] is an approximate solution of the system at time ih, i=∈{0,1,2, . . . , m}, and |x_{m,0} [symbol] =|x_{m,1} [symbol] =|x_{m,2} [symbol] = . . . =|x_{m,p} [symbol] is an approximate solution of [symbol] (t)=e^{At}yᵢₙ at t=mh.

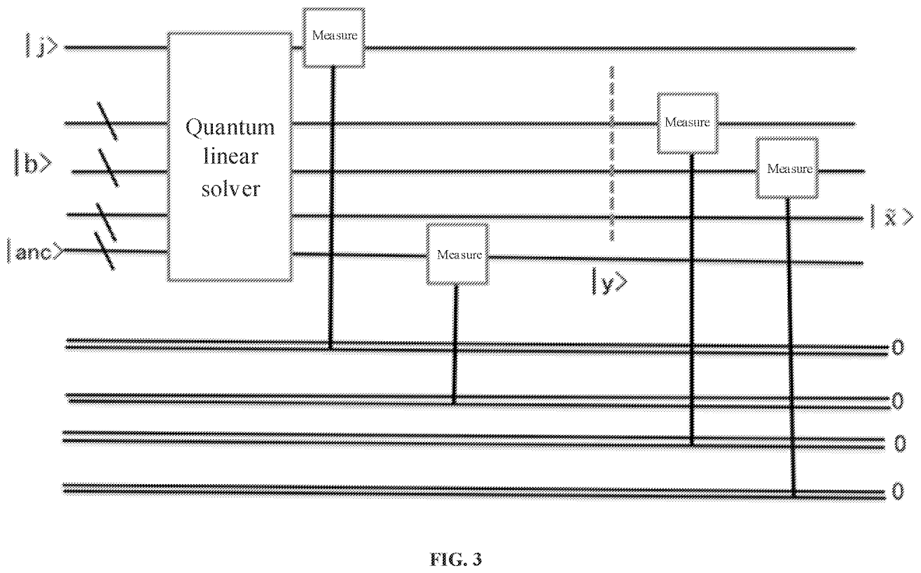

At S203: a quantum circuit corresponding to a quantum linear solver used for solving the target system of linear equations is constructed. In one embodiment, a preset matrix Oracle related to the target system of linear equations may be firstly constructed, and then a quantum logic gate function module is constructed based on the Oracle, so as to construct a quantum circuit corresponding to a quantum linear solver based on the quantum logic gate function module, where the quantum logic gate function module includes a first functional module, a second functional module, and a third functional module. In other words, a quantum circuit corresponding to a quantum linear solver including the Oracle and quantum logic gate functional modules is constructed, a quantum state evolution operation is performed on the quantum circuit, and measurement is performed to obtain a quantum state of the evolved quantum circuit. For ease of understanding, construction of the quantum circuit will first be described in detail below in conjunction with FIGS. 3 to 5.

FIG. 3 is a schematic diagram of a quantum circuit for solving a system of nonlinear equations according to an embodiment of the present disclosure. As shown in FIG. 3, a quantum linear quadratic linear solver module and four measurement modules are shown. By constructing a related Oracle of Ay=b, the Oracle may be regarded as an interface for inputting equation information to the quantum circuit, or as input of a quantum linear solver algorithm. Specifically, a quantum state (y) may be output though Oracleinput the Oracle of Ay=b, |y [symbol] =Σᵢ₌₀^{c}Σⱼ₌₀^{β}^{ᵢ}|i,j [symbol] |y_{i,j} [symbol] . A first bit register of |y [symbol] is measured, and a normalized approximate solution |y_{0.0} [symbol] =|\tilde{x} [symbol] of the original quadratic nonlinear equation is obtained when |0,0 [symbol] is measured.

In some embodiments, a system of quantum linear ordinary differential equation solver module and five measurement modules may be included. By constructing a related Oracle of

$$\frac{d \vec{y}}{dt} = A \vec{y} , \vec{y} ( 0 ) = {y}_{i n} ,$$

the Oracle may be regarded as an interface for inputting equation information to the quantum circuit, or as input of a quantum linear solver algorithm for a system of ordinary differential equations. Specifically, the Oracle of

$$\frac{d \vec{y}}{dt} = A \vec{y}$$

and evolution time T may be input to output a quantum state |y(T) [symbol] at time T. Some bit registers of |y(T) [symbol] are measured, and |\vec{y}_{0,0}(T) [symbol] is obtained when |0,0 [symbol] is measured, where the obtained |\vec{y}_{0,0}(T) [symbol] satisfies: |y_{0,0}(T) [symbol] =|ũ(T) [symbol] =|u(T) [symbol] , so that an output state |ũ(T) [symbol] representing an approximate solution of the target system of linear ordinary differential equations can be obtained.

For the construction manner of OracleO_{A} of the matrix A. A may be regarded as a c+1-dimensional block matrix, and an expression and corresponding positions of non-zero block matrix elements of A may be obtained by O(poly(c)) times of classical operations. Then, the Oracles of F₁, F₂ are used to extract non-zero element positions and non-zero element values of matrix elements in the block matrix, and OA is constructed by implementing arithmetic operations in this process with a quantum circuit, where a query complexity is O(poly(c)) for Oracles of F₁, F₂ in the construction process. Since only some simple arithmetic operations are involved, a circuit length is also O(poly(c)). Similarly, the operation O_{b} for preparing |b [symbol] can also be implemented by O_{F}_{₀}, where the query complexity is O(poly(c)).

It can be understood that constructing the quantum circuit corresponding to the quantum linear solver mainly includes constructing a sub-quantum circuit corresponding to the quantum linear solver module shown in FIG. 3, including: firstly constructing a quantum circuit that implements a first functional module V, where the first functional module is defined as

$$V \vert {0}^{m} 〉 := \frac{1}{\sqrt{α}} {\sum }_{i} \sqrt{{α}_{i}} \vert i 〉 ,$$

$$α := 4 {\sum }_{j = 0}^{{j}_{0}} {( - 1 )}^{j} \frac{{\sum }_{i = j + 1}^{b} ( \begin{matrix}2 b \\ b + i\end{matrix} )}{{2}^{2 b}} ,$$

$${j}_{0} = \sqrt{blog ( 4 b / ϵ )} ,$$

$$b = {κ}^{2} log ( κ / ϵ ) ;$$

next, constructing a quantum circuit that implements a second functional module combination, where the quantum circuit for the second functional module combination includes T, W and T⁺, the T=Σ_{j∈[N]}|Ψⱼ [symbol] j|, W=S·(2T·T⁺−I_{4N}_{²}), the S is a unitary matrix of an exchange operation module, the T⁺ is a transposed conjugate of the T, the

$$\vert {Ψ}_{j} 〉 := \vert j 〉 ⊗ \frac{1}{\sqrt{d}} {\sum }_{k ∈ [ N ] : {A}_{jk} \neq 0} ( \sqrt{{A}_{jk}^{*}} \vert k 〉 + \sqrt{1 - \vert {A}_{jk} \vert} \vert k + N 〉 ) ,$$

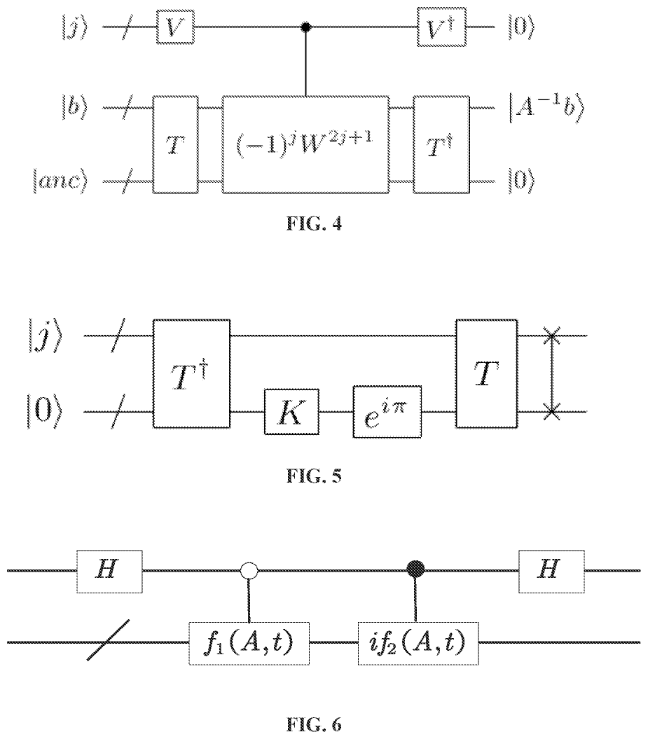

and I_{4N}_{²} is a 4N²-dimensional identity matrix; further constructing a quantum circuit that implements a third functional module V⁺, where the third functional module is a transposed conjugate form of the first functional module; and sequentially inserting the first functional module, the second functional module and the third functional module into the quantum circuit to form a quantum circuit corresponding to a quantum linear solver, as shown in FIG. 4.

FIG. 4 is a schematic diagram of a quantum circuit corresponding to a quantum linear solver according to an embodiment of the present disclosure. In the quantum circuit shown in FIG. 4, V, T represent Oracles with different functions, “†” represents transposed conjugate. T represents an overall functional module T of an H gate and a combination of various Oracles, a function of the T module is to transform |j [symbol] into |Ψⱼ [symbol] , the obtained matrix input to the T module is an N order matrix, and the constructed T module may be equivalent to a quantum logic gate in the quantum circuit, the matrix form of which is: Σ_{j∈[N]}|Ψⱼ [symbol] j|, where [symbol] j| is a quantum state bra.

It should be noted that to solve the target system of linear equations, a quantum circuit diagram about a walk operator W should be constructed first. It will be understood by those skilled in the art that any simple function can be linearly approximated as a linear combination of other functions, and an inverse function of a matrix can be approximated through a Chebyshev polynomial. The Chebyshev polynomial has to be implemented in the framework of quantum walks.

Since quantum walks are performed on some states |φⱼ [symbol] in space [symbol] ^{2N}⊗ [symbol] ^{2N} define a mapping T:=Σ_{j∈[N]}|φⱼ [symbol] j|, from [symbol] ^{N} to [symbol] ^{2N}⊗ [symbol] ^{2N}

$$\vert {Ψ}_{j} 〉 := \vert j 〉 ⊗ \frac{1}{\sqrt{d}} {\sum }_{k ∈ [ N ] : {A}_{jk} \neq 0} ( \sqrt{{A}_{j k}^{*}} \vert k 〉 + \sqrt{1 - \vert {A}_{jk} \vert} \vert k + N 〉 )$$

and a walk operator:

$$W = S ( 2 T {T}^{†} - I )$$

The operator S performs a flip operation of a product state in |φⱼ), so:

$${T}^{†} {W}^{n} T \vert b 〉 = \vert {0}^{m} 〉 ( H ) \vert b 〉 + \vert {⊥}_{b} 〉$$

[symbol] (λ) is a Chebyshev polynomial of the first kind.

It should be noted that as in the above form of |Ψⱼ [symbol] , a combination of vertical lines and angle brackets is used to describe a quantum state, representing that the quantum state is a vector (also called a state vector, a basis vector, or the like), where |Ψⱼ [symbol] represents a ket, and [symbol] Ψⱼ| represents a bra.

FIG. 5 is a schematic diagram of a quantum circuit for a walk operator W according to an embodiment of the present disclosure. As shown in FIG. 5, since W=S(2TT^{†}−I_{4N}_{²}), S may be constructed through a group of exchange operations (such as a SWAP gate, where the symbol of two connected bold Xes in the qubits of FIG. 5 represent a SWAP gate), and the rest is 2TT^{†}−I_{4N}_{²}.

To construct 2TT^{†}−I_{4N}_{²}, a unitary operator form of T is desired to be constructed, and the unitary operator Tᵤ is defined to satisfy:

$${T}_{u} \vert j 〉 \vert 0 〉 = \vert {Ψ}_{j} 〉$$

so:

$${T}_{u} ( {\sum }_{j} \vert j 〉 〈 j \vert ⊗ ( 2 \vert 0 〉 〈 0 \vert - {I}_{2 N} ) ) {T}_{u}^{†} = {\sum }_{j} \vert {φ}_{j} 〉 〈 {φ}_{j} \vert ⊗ ( 2 \vert 0 〉 〈 0 \vert - {I}_{2 N} ) = 2 T {T}^{†} - {I}_{4 {N}^{2}}$$

$$where$$

$$\vert {φ}_{j} 〉 = \frac{1}{\sqrt{d}} {\sum }_{k ∈ [ N ] : {A}_{jk} \neq 0} ( \sqrt{{A}_{j k}^{*}} \vert k 〉 + \sqrt{1 - \vert {A}_{jk} \vert} \vert k + N 〉 ) ,$$

$$\text{and:}$$

$$K = 2 \vert 0 〉 〈 0 \vert - {I}_{2 N} .$$

It should be noted that this schematic diagram merely shows a part of the quantum circuit related to the present application, and the identifiers and connection relationships in the figure are merely examples and do not constitute any limitation to the present disclosure. In addition to the Chebyshev linear solver mentioned above, an HHL algorithm or a variational quantum linear solver can also be used for solution.

Returning to FIG. 2, it further shows that at S204: based on the quantum circuit corresponding to the quantum linear solver, quantum state evolution and measurement are performed on the target system of linear equations to solve the target system of linear equations. In one embodiment, a target matrix in the target system of linear equations is firstly input into the quantum circuit corresponding to the quantum linear solver through the preset matrix Oracle, and based on the input, the quantum linear solver executes the quantum state evolution and measures a quantum register in the corresponding quantum circuit to solve the target system of linear equations. Specifically, according to the constructed matrix A and the corresponding Oracle, a quantum linear solver is used to solve the linear system. The input of the quantum linear solver is the OracleOracle constructed as above, and a solution of the target system of linear equations is obtained by the quantum linear solver.

It should be noted that the quantum OracleOracle is a black box that represents transformation of a certain quantum state. A typical example of the quantum OracleOracle is linear system: O|x [symbol] |0 [symbol] =|x [symbol] |f(x) [symbol] , where in calculation of f(x), the first quantum register is used as input and the second quantum register is used as output. Another example is QRAM, which can be regarded as a kind of OracleOracle. Many quantum algorithms use OracleOracles, but do not consider implementation of the OracleOracle, while it may be decomposed into quantum gates, or implemented as a QRAM. In Qpanda, the “OracleOracle” function can be used to define. OracleOracle is considered to have a name provided by a user.

In quantum applications, an OracleOracle or a combination of Oracles is constructed, and the internal principle of the Oracle or combination is the method flow of the present disclosure. Specifically, the Oracle may be understood as a module (similar to a black box) that completes a specific function in a quantum algorithm, and has specific implementations for specific problems.

At present, the existing quantum circuit can be constructed by means of only the existing single quantum logic gate, double quantum logic gate, and the like, and usually has the following defects:

For a quantum circuit with relatively complex functions, a very large number of qubits are desired. The simulation with a classical computer will consume a huge memory space, involve a very large number of logic gates and a very long time, and some complex algorithms are difficult to implement with the quantum circuit.

On this basis, specific complex functions are realized through Oracle simulation, and controlled and transposed conjugate operations are implemented. Parameters input by a user to the Oracle may include: an Oracle name (used to identify a functional purpose of the Oracle, such as O_{A1}), qubits, matrix elements, and the like.

The advantage of this method is that the Oracle is regarded as a known module as a whole without paying attention to internal implementation details, and the representation of the quantum application scenario such as a quantum circuit, is very simple and clear. Since the Oracle functional modules of classical simulation can be equivalent to quantum logic gates, the constructed quantum circuit is simplified, thereby saving the memory space required for runtime and speeding up simulation verification of the quantum algorithm.

At S205: based on an obtained solution of the target system of linear equations, a solution of the target system of nonlinear equations to be solved is determined.

In an implementation scenario, the quantum state evolution of the quantum state from |b [symbol] to |A⁻¹b [symbol] may be performed by the quantum circuit shown in FIG. 4. Exemplarily, the entire quantum circuit is operated to measure |j [symbol] and |anc), and when both |j [symbol] and |anc [symbol] are collapsed to |0 [symbol] , |A⁻¹b [symbol] can be obtained in the second register.

Similarly, according to the quantum circuit corresponding to the quantum linear solver, a solution of the target system of linear equations can be obtained by measuring some quantum registers on the corresponding quantum circuit, and finally, according to the obtained solution of the target system of linear equations, a solution of a system of quadratic nonlinear equations or of nonlinear ordinary differential equations can be calculated. For a system of quadratic nonlinear equations, since each component in \tilde{x} is in the form of a tensor product of vᵢ, the solution of the system of quadratic nonlinear equations is obtained by calculating y₀. For a system of nonlinear ordinary differential equations, since each component in \vec{y} is in the form of a tensor product of vᵢ, the solution of the system of nonlinear ordinary differential equations to be processed is obtained by calculating \vec{y}(0). For example, some qubit registers of |y(T)) may be measured to obtain a quantum state with a preset accuracy close to a normalized solution of the equation to be solved. The measurement may be divided into two steps: (1) measuring a first qubit register in the defined |x [symbol] , where if the measured value is s, s=|m(k+1)+j [symbol] , j=0, 1, . . . , p, a second quantum register of |x [symbol] has |y(T) [symbol] ; and (2) measuring a first qubit register of |y(T) [symbol] , where if the result is |0,0 [symbol] , an exact solution with a preset accuracy close to |u(T)/∥u(T)|∥ [symbol] is obtained in a second qubit register of |y(T) [symbol] .

It should be noted that the first qubit register and the second qubit register are a first register and a second register of an output state of the quantum circuit corresponding to the quantum linear solution algorithm, which are subdivisions of the quantum circuit where |A⁻¹b [symbol] is located in FIG. 4. The quantum circuit in FIG. 4 merely shows a part of the quantum circuit related to the present application, and the identifiers and connection relationships in the figure are merely examples and do not constitute any limitation to the present.

Further, for a success rate of the algorithm, |y₀ [symbol] is desired. The success rate is a probability of |0,0 [symbol] obtained by measuring the first quantum register in |y [symbol] =Σᵢ₌₀^{c}Σⱼ₌₀^{β}^{ᵢ}|i,j [symbol] |y_{i,j} [symbol] , and specifically expressed as:

$$p = \frac{{‖ {y}_{0} ‖}^{2}}{{‖ y ‖}^{2}} ,$$

y=[y₀, y₁, . . . , y_{c}], assuming ∥y₀∥=ηR, where η is a constant. R is defined as: R:=max{4∥F₁⁻¹∥²∥F₀∥∥F₂∥, ∥F₀∥}, then |F₁⁻¹|<1, and when

$$R \leq \frac{\sqrt{2}}{2} : \frac{{‖ {y}_{0} ‖}^{2}}{{‖ y ‖}^{2}} \geq \frac{{η}^{2} ( 1 - 2 {R}^{2} )}{{η}^{2} ( 1 - 2 {R}^{2} ) + 4} .$$

Therefore, given the defined system of quadratic nonlinear equations F₀+F₁x+F₂x^{⊗2}=0 and define the parameters: ϵ<0.01, R:=max {4∥F₁⁻¹∥²∥F₀∥∥F₂∥, ∥F₀∥}, α:=∥F₁⁻¹∥∥F₀∥, β:=∥F₁⁻¹∥∥F₂∥, η=∥x∥/R.

$$c = ⌈ {log}_{\frac{1}{4 αβ}} \frac{4 α}{η R ϵ ( 1 - 4 αβ )} ⌉ ,$$

and G:=∥F₁⁻¹∥(1+(c+1)∥F₂∥, then it satisfies: when ∥F₁⁻¹∥<1, G<1, and

$$R < \frac{\sqrt{2}}{2} ,$$

there is a quantum algorithm with a success rate Ω(1) used to get the normalized quantum state |\tilde{x} [symbol] , which satisfies ∥\tilde{x}−x∥≤ϵ, where x is an exact resolution. A query complexity of the algorithm for Oracles of F₀, F₁ and F₂ is O(s(A)κ(A) poly(log(s(A)κ(A)/ϵ))). Considering the success rate of the algorithm, and through optimization by an amplitude amplification algorithm, the query complexity at the success rate Ω(1) is:

$$O ( \frac{κ s}{η \sqrt{1 - 2 {R}^{2} ( 1 - G )}} poly ( log ( \frac{\vert {F}_{1}^{- 1} ‖ ‖ {F}_{0} ‖}{ϵη R} ) ) ) .$$

Following the above example, solve Ay=b, and get the component y₀ of y as:

$$\tilde{x} = {y}_{0} = {[ - 4.8765625 \times {10}^{- 2} , 5.1265625 \times {10}^{- 2} ]}^{T}$$

A solution obtained in an iterative method is:

$$x = [ - 4.8765625 \times {10}^{- 2} , 5.1265625 \times {10}^{- 2} ]$$

$$\text{so:}$$

$$‖ x - \tilde{x} ‖ = 1.1061184 \times {10}^{- 6} .$$

In addition, a structure of the matrix A in the nonlinear ordinary differential equation needs to satisfy the form that:

$$\frac{d {\vec{y}}_{i , j}}{dt} = ( {\sum }_{j = 0}^{i} {I}_{n}^{{⊗}_{j}} ⊗ {F}_{1}^{′} ⊗ {I}_{n}^{{⊗}_{i - j}} ) {\vec{y}}_{i , j} + {\sum }_{k = 0}^{i} ( {I}_{n}^{k} ⊗ {F}_{2}^{′} ⊗ {I}_{n}^{{⊗}_{i - k}} ) {ν}_{{a}_{i , j , 0}} ⊗ … ⊗ {v}_{{α}_{i , j , k - 1}} ⊗ ( {\sum }_{l = 0}^{{a}_{i , j , k} - 1} ⊗ {v}_{{a}_{i , j , k}} - 1 - l ) ⊗ {ν}_{{a}_{i , j , k + 1}} ⊗ … ⊗ {v}_{{a}_{i , j , i}}$$

where I is an n order identity matrix, vₐ_{_{i,j,0}}⊗ . . . ⊗vₐ_{_{i,j,k−1}}⊗vₗ⊗vₐ_{_{i,j,k}}−1−l⊗vₐ_{_{i,j,k+1}}⊗ . . . ⊗vₐ_{_{i,j,i}}∈\vec{y}ᵢ₊₁, so

$$\frac{d \vec{y}}{dt} = A \vec{y} ,$$

[symbol]

(0)=yᵢₙ, which may be written as:

$$\frac{d}{dt} [ \begin{matrix}{\vec{y}}_{0} \\ {\vec{y}}_{1} \\ {\vec{y}}_{2} \\ ⋮ \\ {\vec{y}}_{c - 1} \\ {\vec{y}}_{c}\end{matrix} ] = [ \begin{matrix}{A}_{0 , 0} & {A}_{0 , 1} & 0 & 0 & 0 & 0 \\ 0 & {A}_{1 , 1} & {A}_{1 , 2} & 0 & 0 & 0 \\ 0 & 0 & {A}_{2 , 2} & ⋱ & 0 & 0 \\ 0 & 0 & 0 & ⋱ & {A}_{c - 1 , c - 2} & 0 \\ 0 & 0 & 0 & 0 & {A}_{c - 1 , c - 1} & {A}_{c - 1 , c} \\ 0 & 0 & 0 & 0 & 0 & {A}_{c , c}\end{matrix} ] [ \begin{matrix}{\vec{y}}_{0} \\ {\vec{y}}_{1} \\ {\vec{y}}_{2} \\ ⋮ \\ {\vec{y}}_{c - 1} \\ {\vec{y}}_{c}\end{matrix} ]$$

where A_{i,i} is a nⁱ⁺¹βᵢ-dimensional array, expressed as:

$${A}_{i , i} = I {β}_{i} ⊗ ( {\sum }_{j = 0}^{i} {I}_{n}^{j} ⊗ {F}_{1}^{′} ⊗ {I}_{n}^{{⊗}_{i - j}} )$$

A_{i,i+1} is a nⁱ⁺¹βᵢ×nⁱ⁺²βᵢ₊₁-dimensional matrix, and |y(t)) is defined to represent [symbol] (t):

$$\vert y ( t ) 〉 = {\sum }_{i = 0}^{c} {\sum }_{j = 0}^{{β}_{i}} \vert i , j 〉 \vert {y}_{i , j} ( t ) 〉$$

The above quantum linear algorithm is used to solve

$$\frac{d \vec{y}}{dt} = A \vec{y} ,$$

[symbol]

(0)=yᵢₙ, and [symbol] (t) is written as: [symbol] (t)=e^{At} [symbol] (0).

It can be seen that in the present application, a system of quadratic nonlinear equations or a system of nonlinear ordinary differential equations is converted into a matrix and vector information of linear equations in a homotopy perturbation method, and encodes the same to a quantum state, the classical data structure is connected with quantum states in the quantum field, and the evolution operation of encoding the classical data structure into a quantum state is performed to obtain a quantum state of the evolved quantum circuit, which can accelerate solution of the system of quadratic nonlinear equations or system of nonlinear ordinary differential equations of high complexity by means of the superposition property of quantum, thereby expanding the simulation application scenarios of quantum computation.

Compared with the existing art, the present disclosure firstly converts a system of quadratic nonlinear equations or a system of nonlinear ordinary differential equations to determine a target system of linear equations, and then constructs a quantum circuit corresponding to the quantum linear solver, runs the quantum circuit and performs measurement to solve the target system of linear equations, and determines the solution of the system of quadratic nonlinear equations or the system of nonlinear ordinary differential equations based on the solution of the target system of linear equations. Therefore, by means of related properties of quantum, the technology of solving a system of quadratic nonlinear equations or a system of nonlinear ordinary differential equations with a quantum algorithm can be implemented, and the complexity and difficulty in solving a system of quadratic nonlinear equations or a system of nonlinear ordinary differential equations can be reduced, thereby filling in related technical gaps in the field of quantum computation.

According to the foregoing, it is possible to embed the preset system of pseudo-linear equations into the linear system (i.e., form a system of linear equations), and then solve the system of linear equations. In recent years, quantum algorithms for solving a system of linear equations Ax=b have been continuously proposed. For example, Childs et al. have proposed an algorithm for constructing matrix inverses with series expansion, and constructed a new quantum linear solver with a complexity of [symbol] (sκ²poly(log(sκ/ϵ))), where performance on ϵ is improved exponentially, and in addition, the complexity is also optimized to O(sκpoly(log(sκ/ϵ))) through VTAA. Recently, the work of using QSVT to construct a quantum linear solver is also proposed, which does not need to be optimized with VTAA, and the complexity is [symbol] (sκpoly(log(Sκ/ϵ))).

From the above work, it can be seen that the complexity of the optimal quantum linear solver is linearly related to the system condition number κ, but in practical problems, a linear system with a large condition number may be encountered, such as x is on a polynomial magnitude of n. When solving such problems, the advantage of the quantum linear solver is severely reduced, and there is no quantum advantage anymore. When encountering an ill-conditioned linear system, the classical algorithm for solving a system of linear equations generally pre-processes the linear system to construct a new well-conditioned linear system, and the solution is the same as the original system, thereby effectively solving the ill-conditioned linear system. In view of this, the present application further proposes to add the classical polynomial pre-processing to the HHL algorithm, to construct an HHL algorithm with a polynomial preprocessor, which reduces the condition number of the linear system to be solved, thereby improving the performance of the HHL algorithm and expanding the application scope of the HHL algorithm.

In one embodiment, firstly, the above target system of linear equations may be embedded into a linear system, where the linear system includes a first matrix A and a first vector b, and the linear system includes a condition number κ_{A}.

The linear system is a mathematical model that refers to a system composed of linear operators that satisfies both superposition and uniformity (also known as homogeneity). At present, the linear system is the core of many scientific and engineering fields. For a linear system Ax=b to be processed, element information and dimensions of a first matrix A and a first vector b can be obtained respectively, where the first matrix A may be an invertible Hermitian matrix. The Hermitian matrix is a common matrix type that can be simply put as a self-conjugate matrix, in which each element at column j in row i of the matrix is conjugated and equal to an element at column i in row j. Each element on a main diagonal of the Hermitian matrix is a real number with an eigenvalue also being a real number.

Next, a polynomial p(A) for the first matrix A in the linear system is calculated.

Specifically, for the linear system Ax=b to be processed, A is an invertible Hermitian matrix with a condition number being κ_{A}=∥A∥∥A⁻¹∥. A preprocessing process of the linear system is to find and calculate the polynomial p(A) for the first matrix A, which may include the following steps:

At step 1: a function ƒₘ(x) and a preset interval S for solving the polynomial are constructed, where the function ƒₘ(x) satisfies fₘ(x)=pₘ (x)x, and fₘ(xᵢ)+(−1)ⁱE=1, the m is a polynomial order, the i=0,1,2, . . . , m+1, the S∈[1/κ_{A}, 1], and the E is a deviation amplitude.

At step 2: m+1 points in the preset interval are selected, and a solution of a system of linear equations fₘ(xᵢ)+(−1)ⁱE=1 is acquired, where the m+1 points are respectively x₁, x₂, . . . , xₘ₊₁, and satisfy x₁=1/κ, xₘ₊₁=1.

At step 3: the acquired solution of the system of linear equations is substituted into fₘ(x) to obtain a set N′ of points corresponding to local maximum values of |1−fₘ(x)|.

At step 4: it is judged whether an absolute value of fₘ(x)−1 is the same for any x∈N′, and whether a sign of fₘ(x)−1 changes between plug and minus alternately as x increases, and if the absolute value of fₘ(x)−1 is the same for any x∈N′, and the sign of fₘ(x)−1 changes between plug and minus alternately as x increases, a current fₘ(x) is determined as an optimal polynomial.

At step 5: if the absolute value of fₘ(x)−1 is not the same for any x∈N′, or the sign of fₘ(x)−1 doesn't change between plug and minus alternately as x increases, elements in x₁, x₂, . . . , xₘ₊₁ are replaced with elements in the set N′ according to a rule including: replacing x₂, . . . , xₘ with elements in the set N′ while x₁, xₘ₊₁ remain unchanged, and then, the step of acquiring a solution of the system of linear equations fₘ(xᵢ)+(−1)ⁱE=1 is performed again, until an optimal fₘ(x) satisfying the judgment condition is obtained.

Specifically, the problem of calculating the polynomial p(A) of the first matrix A used for linear system preprocessing to minimize κ_{A}′ may be converted into a minimax approximation problem, which can be then solved by a Remez algorithm to obtain the optimal p(A).

First, it may be defined that: ∥l(x)−p(x)x∥_{S}=max_{x∈S}|l(x)−p(x)x|, where S=[−1, −1/κ]∪[1/κ, 1], and l(x) is defined as:

$$l ( x ) = \{ \begin{matrix}1 , x > 0 \\ - 1 , x > 0\end{matrix} .$$

Considering that p(x) is an even function, l(x)−p(x)x is an odd function. Therefore, only an interval S=[1/κ, 1] of x>0 is considered, and the optimal p(x) satisfies:

$${min}_{p ∈ {π}_{even}^{2 m}} {‖ 1 - p ( x ) x ‖}_{S} ,$$

where πₑᵥₑₙ^{2m} represents a set of 2 m order even functions.

The Remez algorithm is an iterative algorithm for approximating a function through a minimax norm. Assuming that p(x) may be expressed as: pₘ(x)=Σᵢ₌₀^{m+1}αᵢx²ⁱ⁺¹, it is defined that: fₘ(x)=pₘ(x)x=Σᵢ₌₀^{m+1}αᵢx²ⁱ⁺¹. First, m+1 points X={x₁, x₂, . . . , xₘ₊₁} are selected in the interval S∈[1/κ, 1], where x₁=1/κ, and xₘ₊₁=1. Second, the linear equation system fₘ(xᵢ)+(−1)ⁱE=1, i=0,1,2, . . . , m+1 is solved to obtain a solution α₁, α₂, . . . , αₘ, E. Then, α₁, α₂, . . . , αₘ is substituted into fₘ(x) to obtain a set N′ of points corresponding to local maximum values of g(x)=|1−fₘ(x)|. Finally, it is judged whether an absolute value of fₘ(x)−1 is the same for any x∈N′, and whether a sign of fₘ(x)−1 changes between plug and minus alternately as x increases. If the absolute value of fₘ(x)−1 is the same for any x∈N′, and the sign of fₘ(x)−1 changes between plug and minus alternately as x increases, a current fₘ(x) is determined as an optimal polynomial. If the absolute value of fₘ(x)−1 is not the same for any x∈N′, or the sign of fₘ(x)−1 does not change between plug and minus alternately as x increases, elements in X are replaced with elements in the set N′ according to a rule including: x₂, . . . , xₘ are replaced with elements in the set N′ while x₁, xₘ₊₁ remain unchanged. Then, the step of acquiring a solution of the system of linear equations pₘ (xᵢ)+(−1)ⁱE=1, i=1, 2, . . . , m+1 is performed again, until an optimal pₘ(x) meeting the judgment condition is obtained.

Further, according to the above polynomial p(A), the linear system is preprocessed to obtain a second matrix A′ and a second vector b′. Specifically, according to the obtained optimal polynomial p(A), a new linear system A′x=b′ to be processed is constructed, including obtaining a second matrix A′=p(A) A and a second vector b′=p(A)b, so that the new linear system to be processed can be solved more efficiently. In general, a system of linear equations with a smaller condition number is easier to solve. Therefore, p(A) has to make the condition number κ_{A}′ of the preprocessed second matrix A′ satisfy κ_{A}′<<κ_{A}. In one embodiment, according to the above polynomial p(A), preprocessing the linear system to obtain the second matrix A′ and the second vector b′ may further include: constructing an operator P̅ based on the polynomial P(A), and applying the operator P̅ to the quantum state |b [symbol] to obtain a quantum state |b′ [symbol] , where the quantum state |b′ [symbol] is a quantum state corresponding to the second vector b′, and multiplying the polynomial P(A) by the first matrix A to obtain the second matrix A′. In an implementation scenario, the operator P̅ corresponding to the polynomial P(A) may be prepared through quantum signal processing (QSP).

It should be noted that p(A) may be selected in various manners, such as a Neumann polynomial, a Chebyshev polynomial, a Least Square polynomial, or the like, which are not limited herein.

Based on the obtained second matrix A′ and second vector b′, a quantum circuit corresponding to an HHL algorithm may be constructed based on the second matrix A′ and the second vector b′, and used to perform quantum state evolution and measurement operations to solve the target system of linear equations.

The problem of solving a system of linear equations is a basic problem in many fields. In recent years, algorithms for solving the system of linear equations Ax=b have been continuously proposed. Harrow et al. proposed a quantum algorithm, i.e., an HHL algorithm, for solving a system of linear equations in 2009, which has a query complexity

$$𝒪 ( \frac{s {κ}^{2}}{ϵ} poly ( log ( sκ / ϵ ) ) ) ,$$

where s represents a sparsity of the first matrix A, and κ=∥A∥∥A⁻¹∥ represents a condition number of the first matrix A.

Specifically, due to an exponential acceleration effect compared with the classical algorithm under certain conditions, the HHL algorithm can be widely applied in data processing, machine learning, numerical calculation, fluid mechanics problem processing and other scenarios in the future. In this embodiment, the HHL algorithm may be used to solve a linear equation, including: inputting, for the quantum circuit, an initial quantum state |b′ [symbol] and an operator U̅, and performing quantum state evolution and measurement operations to obtain a final quantum state of the evolved quantum circuit, where the operator U̅=e^{iA′t} and the t is a constant.

The initial quantum state |b′ [symbol] and the operator U̅ are input, and a solution x of the linear equation is output, which satisfies A′x=b′, i.e., x=A′⁻¹‘b’. Therefore, the second matrix A′ should be an invertible matrix, and for the second vector b′, since data of the second vector b′ needs to loaded to the quantum circuit as described below, a dimension number of the second vector b′ should be able to be expressed as a positive integer power of 2. If the dimension number cannot be expressed in the form of a positive integer power of 2, zeros are filled into elements of the second vector b′ until the dimension number can be expressed in the form of a positive integer power of 2.

Specifically, constructing the quantum circuit corresponding to the HHL algorithm includes the following steps:

At step 1: several qubits including an auxiliary qubit, a first qubit, and a second qubit are obtained, where initial states of the auxiliary qubit and the first qubit are set to |0 [symbol] , an initial state of the second qubit is set to |b′ [symbol] =Σᵢ₌₁^{N} b′ᵢ|i [symbol] , the b′ is an i^{th} element of the second vector b′, and the N is a dimension number of the second vector.

Specifically, the number of the qubits to obtain may be determined by a user according to the needs, or a relatively sufficient number of qubits may be obtained to satisfy the computing needs when the computing resources are sufficient.

The obtained several qubits including the auxiliary qubit, the first qubit, and the second qubit may be specifically represented by qubits. For example, |0 [symbol] on the initial qubit indicates that the quantum state of the qubit is |0 [symbol] , and |1 [symbol] indicates that the initial quantum state is |1 [symbol] .

It should be noted that, for the convenience of subsequent distinctions, the obtained several qubits may be divided into auxiliary qubits, first qubits, and second qubits. The specific distinction names are not limited herein, and the initial state of each qubit may be prepared by an existing amplitude coding method or quantum state coding method. The initial states of the auxiliary qubit and the first qubit is set to |0), and the initial state of the second qubit is set to |b′ [symbol] =Σᵢ₌₁^{N}b′ᵢ|i [symbol] . For example, for a 4-dimensional second vector b′=[b′₁, b′₂, b′₃, b′₄], i.e., N=4, data of the second vector b′ is coded to the quantum state amplitude to obtain:

$$\vert {b}^{′} 〉 = \frac{1}{\sqrt{{{b}^{′}}_{1}^{2} + {{b}^{′}}_{2}^{2} + {{b}^{′}}_{3}^{2} + {{b}^{′}}_{4}^{2}}} {\sum }_{i = 1}^{4} {b}_{i} \vert i 〉 = \frac{1}{\sqrt{{{b}^{′}}_{1}^{2} + {{b}^{′}}_{2}^{2} + {{b}^{′}}_{3}^{2} + {{b}^{′}}_{4}^{2}}} {{b}^{′}}_{1} \vert 0 〉 + {{b}^{′}}_{2} \vert 1 〉 + {{b}^{′}}_{3} \vert 2 〉 + {{b}^{′}}_{4} \vert 3 〉 ) = \frac{1}{\sqrt{{{b}^{′}}_{1}^{2} + {{b}^{′}}_{2}^{2} + {{b}^{′}}_{3}^{2} + {{b}^{′}}_{4}^{2}}} {{b}^{′}}_{1} \vert 00 〉 + {{b}^{′}}_{2} \vert 01 〉 + {{b}^{′}}_{3} \vert 10 〉 + {{b}^{′}}_{4} \vert 11 〉 )$$

thereby loading the data of the second vector b′ to the quantum state amplitudes of two second qubits in the quantum circuit.

At step 2: a unitary matrix U̅ corresponding to the second matrix A′ is determined.

Specifically, since the second matrix A′ is a Hermitian matrix, the unitary matrix U̅ corresponding to the second matrix A′ can be directly determined, or Hamiltonian simulation may be used to complete the transformation from Hermitian matrix to unitary matrix, thereby obtaining the corresponding unitary matrix U̅=e^{iA′t}; where t is a constant and takes a general value 2π. First, the operator U̅=e^{iA′t} is expanded according to the Jacobi-Anger expansion to determine an exponential expansion of the operator U, where the exponential expansion of the operator Ü is:

$${e}^{i γ t} = {J}_{0} ( t ) + 2 {\sum }_{k = 1}^{∞} {( - 1 )}^{k} {J}_{2 k} ( t ) {T}_{2 k} ( γ ) + 2 i {\sum }_{k = 0}^{∞} {( - 1 )}^{k} {J}_{2 k + 1} ( t ) {T}_{2 k} ( γ ) ,$$

where Jₖ is a k^{th} order Bessel function of the first kind, and Tₖ is a k^{th} order Chebyshev polynomial of the first kind.

The exponential expansion of the operator U̅ is saved in accuracy of a q^{th} order, where the exponential expansion of the operator U̅ in accuracy of the q^{th} order is:

$$\begin{matrix}{e}^{i γ t} = {f}_{1} ( γ , t ) + {f}_{2} ( γ , t ) , \\ where \\ {f}_{1} ( γ , t ) = {J}_{0} ( t ) + 2 {\sum }_{k = 1}^{q} {( - 1 )}^{k} {J}_{2 k} ( t ) {T}_{2 k} ( γ ) , \\ {f}_{2} ( γ , t ) = 2 i {\sum }_{k = 0}^{q} {( - 1 )}^{k} {J}_{2 k + 1} ( t ) {T}_{2 k} ( γ ) , and \\ γ = P ( A ) A .\end{matrix}$$

Second, an operator f̅₁ corresponding to f₁(γ, t) and an operator f̅₂ corresponding to f₂(γ, t) are prepared through quantum signal processing (QSP). Finally, the operator U̅ is constructed through linear combination of unitary operators (LCU), the operator f̅₁ and the operator f̅₂.

When k is a positive integer, Jₖ(−x)=(−1)^{k}Jₖ(x), Tₖ(−x)=(−1)^{k}Tₖ(x), and therefore f₁(γ, t) is an even function, and f₂(γ, t) is an odd function. Therefore, the operators f̅₁, f̅₂ can also be prepared through QSP. After the operators f̅₁, f̅₂ are prepared, an operator U may be constructed through LCU, as shown in FIG. 6. FIG. 6 is a quantum circuit diagram for constructing an operator U̅ according to an embodiment of the present disclosure.

A success rate of constructing U̅ in this way is n, and after amplitude estimation and amplitude amplification, the success rate can be amplified to η≈1. In the subsequent QPE process, O(−log ϵ) controlled U̅ gates will appear, and a success rate of the whole process is

$$ζ = \frac{1}{{ϵ}^{δ}} ,$$

where δ=log η. Therefore, when η approaches 1, the whole algorithm process approaches 1.

At step 3: a first sub-quantum circuit module for phase estimation is constructed and used to decompose the |b′ [symbol] into |b′ [symbol] =Σⱼ₌₁^{N}βⱼ|μⱼ) in eigenspace of the second matrix A′, and the initial state |0 [symbol] |b′ [symbol] of the first qubit and the second qubit is converted into Σⱼ₌₁^{N}βⱼ|λⱼ [symbol] |μⱼ [symbol] , where the |μⱼ [symbol] is an eigenvector of the second matrix A′, the λⱼ is an eigenvalue of the second matrix A′, and the βⱼ is an eigenvector amplitude of the second matrix A′.

Specifically, a first sub-quantum circuit module for phase estimation is constructed and used to decompose the |b′ [symbol] into |b′ [symbol] =Σⱼ₌₁^{N}βⱼ|μⱼ [symbol] in eigenspace of the second matrix A′, and the initial state |0 [symbol] |b′ [symbol] of the first qubit and the second qubit is converted into Σⱼ₌₁^{N}βⱼ|λⱼ|μj [symbol] . It will be understood by those skilled in the art that phase estimation is an important application of quantum Fourier transform (QFT), reflected in that it is the basis of many quantum algorithms.

FIG. 7 is a schematic diagram of a first sub-quantum circuit module corresponding to phase estimation according to an embodiment. The first sub-quantum circuit module shown in FIG. 7 includes: an H gate operation module, a controlled U̅ operator operation module, and a quantum inverse Fourier transform module (module FT^{†} in the figure), where the U̅ operator is a unitary matrix U̅ corresponding to the second matrix A′. After passing through the first sub-quantum circuit module, the quantum state of the auxiliary qubit (corresponding to the uppermost time line in FIG. 7) remain unchanged, the initial state |0 [symbol] of the first qubit (corresponding to the middle time line in FIG. 7) is converted to |λⱼ [symbol] , the initial state |b′ [symbol] of the second qubit (corresponding to the bottom time line in FIG. 7) is decomposed as |b′ [symbol] =Σⱼ₌₁^{N}βⱼ|μⱼ [symbol] .

In fact, the output λⱼ is an estimated value, and the output accuracy of phase estimation can be improved by increasing the number of first qubits. Moreover, in practical applications, an auxiliary quantum register, a first quantum register, and a second quantum register may be provided to respectively store quantum states of the auxiliary qubit, the first qubit, and the second qubit.

At step 4: a second sub-quantum circuit module for performing a controlled rotation operation is constructed to use |λⱼ [symbol] as a control bit to rotate the auxiliary qubit to obtain

$${\sum }_{j = 1}^{N} {β}_{j} \vert {λ}_{j} 〉 \vert {µ}_{j} 〉 ( \sqrt{1 - \frac{{C}^{2}}{{{λ}_{j}}^{2}}} \vert 0 〉 + \frac{C}{{λ}_{j}} \vert 1 〉 ) ,$$

where the C is a normalization constant.

Specifically, a second sub-quantum circuit module for performing a controlled rotation operation is constructed to use |λⱼ [symbol] as a control bit to rotate the auxiliary qubit to obtain

$${\sum }_{j = 1}^{N} {β}_{j} \vert {λ}_{j} 〉 \vert {µ}_{j} 〉 ( \sqrt{1 - \frac{{C}^{2}}{{{λ}_{j}}^{2}}} \vert 0 〉 + \frac{C}{{λ}_{j}} \vert 1 〉 ) .$$

Controlled rotation may also be called “extraction proportion”, because after the phase estimation, the first quantum register will store a series of eigenvalues λⱼ (specifically stored in a ground state |λⱼ [symbol] ), while the input state, i.e., initial state |b′ [symbol] , stored in the second quantum register will be decomposed in the eigenspace of the second matrix A′. Then, through the controlled rotation, a λⱼ value in the ground state will be extracted to the amplitude. The quantum state |0 [symbol] of the auxiliary qubit is converted to obtain

$${\sum }_{j = 1}^{N} ( \sqrt{1 - \frac{{C}^{2}}{{{λ}_{j}}^{2}}} \vert 0 〉 + \frac{C}{{λ}_{j}} \vert 1 〉 ) ,$$

and the quantum state of each qubit is converted from

$${\sum }_{j = 1}^{N} {β}_{j} \vert {λ}_{j} 〉 \vert {µ}_{j} 〉 \vert 0 〉 to {\sum }_{j = 1}^{N} {β}_{j} \vert {λ}_{j} 〉 \vert {µ}_{j} 〉 ( \sqrt{1 - \frac{{C}^{2}}{{{λ}_{j}}^{2}}} \vert 0 〉 + \frac{C}{{λ}_{j}} \vert 1 〉 )$$

by the second sub-quantum circuit. In order to reduce resource occupation, the auxiliary qubit may be set to 1 bit, and C is a constant generally taking a value 1.

It should be noted that the quantum state |x [symbol] =A′⁻¹|b′ [symbol] (more specifically, the quantum state close to |x [symbol] ) can be obtained from the second quantum register, accompanied by a constant factor C. Later, instead of the process of simple measurement and screening of results, amplitude amplification may be used to increase the probability of success.

At step 5: a third sub-quantum circuit module for performing inverse phase estimation is constructed and used to reset |λⱼ [symbol] to |0 [symbol] .

Specifically, those skilled in the art will understand that an inverse operation of phase estimation is a restoration process of phase estimation, or a transposed conjugate operation of phase estimation, with a purpose of resetting |λⱼ [symbol] to |0 [symbol] , specifically converting the quantum state

$${\sum }_{j = 1}^{N} {β}_{j} \vert {λ}_{j} 〉 \vert {µ}_{j} 〉 ( \sqrt{1 - \frac{{C}^{2}}{{{λ}_{j}}^{2}}} \vert 0 〉 + \frac{C}{{λ}_{j}} \vert 1 〉 ) to : {\sum }_{j = 1}^{N} {β}_{j} \vert 0 〉 \vert {µ}_{j} 〉 ( \sqrt{1 - \frac{{C}^{2}}{{{λ}_{j}}^{2}}} \vert 0 〉 + \frac{C}{{λ}_{j}} \vert 1 〉 )$$

At step 6: a measurement operation module for the auxiliary qubit is constructed, so that when the measured quantum state of the auxiliary qubit is |1 [symbol] :

$$\vert {x}^{′} 〉 = \frac{1}{\sqrt{{\sum }_{j = 1}^{N} {( C {{λ}_{j}}^{- 1} {β}_{j} )}^{2}}} {\sum }_{j = 1}^{N} C {{λ}_{j}}^{- 1} {β}_{j} \vert {µ}_{j} 〉 , the \vert {x}^{′} 〉 ∝ \vert x 〉 .$$

Specifically, the quantum measurement operation is applied to the auxiliary qubit, to measure the auxiliary qubit after the inverse operation of phase estimation. After measurement, the state of the auxiliary qubit will collapse to a definite state, where the probability of collapse to |0> is

$$1 - \frac{{C}^{2}}{{{λ}_{j}}^{2}} ,$$

and the probability of collapse to

$$\vert 1 > is \frac{C}{{λ}_{j}} .$$

When the measured quantum state of the auxiliary qubit is |1 [symbol] and C=1, a definite quantum state can be obtained:

$$\vert {x}^{′} 〉 = \frac{1}{\sqrt{{\sum }_{j = 1}^{N} {( C {{λ}_{j}}^{- 1} {β}_{j} )}^{2}}} {\sum }_{j = 1}^{N} C {{λ}_{j}}^{- 1} {β}_{j} \vert {µ}_{j} 〉 ,$$

which, as can be seen, is a corresponding result of amplitude normalization of |x [symbol] =A′⁻¹|b′ [symbol] =Σⱼ₌₁^{N}βⱼλⱼ⁻¹|μⱼ [symbol] . In practical applications, |x [symbol] may be obtained correspondingly according to the application scenario required by the user, or |x′ [symbol] may be directly used for subsequent scenario calculations.

At step 7: the first sub-quantum circuit module, the second sub-quantum circuit module, the third sub-quantum circuit module, and the quantum measurement operation module are sequentially formed into the quantum circuit corresponding to the HHL algorithm.

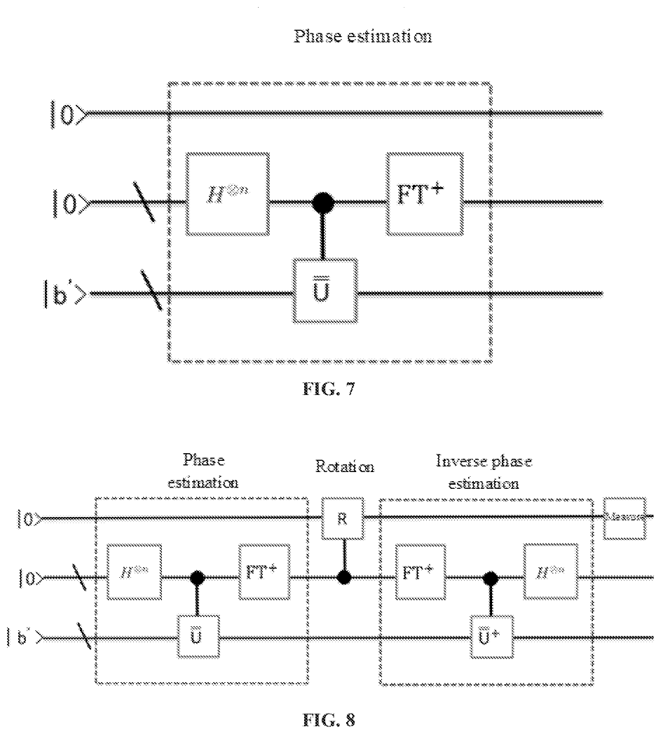

Specifically, as shown in FIG. 8, where a total quantum circuit diagram corresponding to an HHL algorithm according to an embodiment is shown, the first sub-quantum circuit module, the second sub-quantum circuit module, the third sub-quantum circuit module, and the quantum measurement operation module, based on a time sequence of execution, are sequentially formed into a complete quantum circuit, i.e., a total quantum circuit corresponding to the HHL algorithm.

In an optional implementation, a quantum state |b′ [symbol] may be obtained by preparing a quantum state |b [symbol] of the first vector b, constructing an operator P based on the polynomial p(A), and then applying the operator P̅ to the quantum state |b [symbol] , where the quantum state |b′ [symbol] is a quantum state corresponding to the second vector b′. The quantum state |b [symbol] =Σᵢ₌₁^{N}bᵢ|i [symbol] and the operator P̅ is applied to the quantum state |b [symbol] to obtain a quantum state |b′ [symbol] , where the quantum state |b′ [symbol] =Σᵢ₌₁^{N}b′ᵢ|i).

Specifically, the operator P̅ corresponding to the polynomial p(A) is prepared through QSP, where the QSP ensures that a quantum operator mapped from a polynomial defined over a field of real numbers can be prepared if and only if the polynomial is an odd or even function (that is, the polynomial has pure odd or even orders).

It can be seen that an HHL algorithm for polynomial pre-processing is constructed by combining a polynomial preprocessor with a quantum linear solver, which optimizes the complexity of the HHL algorithm with an optimized multiple increasing linearly with the order of the polynomial preprocessing function, thereby improving a capacity of the HHL algorithm in solving ill-conditioned linear systems, and expanding the application range of the HHL algorithm. As the order m increases, the HHL algorithm transitions to a quantum linear solver, and the complexity of the algorithm gradually changes from κ² to κ.

Compared with the existing art, the present disclosure firstly acquires information of a first matrix A and a first vector b in a linear system to be processed, calculates a polynomial p(A) of the first matrix A used for preprocessing the linear system, pre-processes the linear system according to the polynomial p(A) to obtain a second matrix A′ and a second vector b′, constructs a quantum circuit corresponding to an HHL algorithm, performs quantum state evolution and measurement operations according to the second matrix A′ and the second vector b′, to obtain a final quantum state of the evolved quantum circuit, thereby reducing the time, complexity and computation amount in solving linear problems and speeding up solution of the quantum linear algorithm while reducing occupation of hardware resources.

In some embodiments, there is also a case where the condition number κ_{A} of the matrix A is greater than a preset threshold. In this case, a solution of the target system of linear equations may be obtained by constructing a new system of linear equations and then solving the new system of linear equations. Specifically, when the condition number κ_{A} of the matrix A is greater than a preset threshold, the first matrix A and the first vector b are processed through a polynomial preprocessor to obtain a third matrix A″ and a third vector b″, where a condition number κ_{A}′ of the third matrix A″ is less than the condition number κ_{A} of the first matrix A.

In numerical analysis and linear algebra the condition number κ_{A} of the first matrix A is defined as:

$${κ}_{A} = \vert \vert A \vert \vert \vert \vert {A}^{- 1} \vert \vert$$

∥A∥, ∥A⁻¹∥ are norms of the first matrix A and an inverse matrix of the first matrix A, respectively.

The condition number of the matrix describes stretching and compressing capabilities of the matrix to vectors. The larger the condition number of the matrix, the higher the complexity in solving the linear system problem, resulting in disappearance of the acceleration effect of using quantum to solve the linear system problem. Therefore, to achieve a solution performance for linear system problems far exceeds that of an ordinary quantum solver, a preprocessor is used to process the first matrix A and the first vector b to reduce the condition number of the matrix. The preprocessor used in the embodiments of the present disclosure is a polynomial preprocessor.

The preset threshold may be 1, 10, 100, 1000, 10000, or any other value, which is not limited herein.

Further, a new system of linear equations A″x=b″ is constructed based on the first matrix A and the first vector b to solve the unknown x.

After processing the matrix A and the vector b through the polynomial preprocessor to obtain the third matrix A″ and the third vector b″, where the condition number κ_{A}′ of the third matrix A″ is less than the condition number κ_{A} of the matrix A, an ordinary quantum solver may be used to solve the unknown x in the new system of linear equations A″x=b″ constructed from the third matrix A″ and third vector b″.

As mentioned above, the present disclosure provides a polynomial preprocessor to process the matrix A and the vector b in the original system of linear equations Ax=b to obtain a new system of linear equations A″x=b″, where the condition number κ_{A}′ of the matrix A′ in the new system of linear equations is less than the condition number κ_{A} of the matrix A in the original system of linear equations, so that the condition number of the input matrix, and thus the complexity of the linear system problem, are reduced. Then, the new system of linear equations is solved to obtain a common unknown x, so that an acceleration effect in solving linear system problems with quantum is achieved.

In a specific embodiment of the present disclosure, in the aspect of processing the first matrix A and the first vector b through the polynomial preprocessor to obtain the third matrix A″ and the third vector b″, the method includes the following steps.

At step 1: a quantum state |b [symbol] of the first vector b is prepared, and a polynomial P(A) is determined based on a polynomial function P(y) and the first matrix A, where the y is an independent variable.

At step 2: an operator P̅ is constructed based on the polynomial P(A), and the polynomial P(A) is multiplied by the matrix A to obtain the third matrix A″.

At step 3: the operator P is applied to the quantum state |b [symbol] to obtain a quantum state |b′ [symbol] , where the quantum state |b′ [symbol] is a quantum state corresponding to a third vector b″.

The quantum state

$$\vert b 〉 = \frac{1}{‖ b ‖} {\sum }_{i = 0}^{n - 1} {b}_{i} \vert i 〉 ,$$

and we n is a dimension of the first vector b. The operator P̅ is applied to the quantum state (b) to obtain a quantum state |b′ [symbol] , where the quantum state |b′ [symbol] =Σᵢ₌₀ⁿ⁻¹βᵢ|μᵢ [symbol] .

Further, before determining the polynomial P(A) based on the polynomial function P(y) and the matrix A, the method further includes the following steps.

At step 1: an approximate function Kₘ(y) containing parameters is acquired, and a domain of definition of the approximate function Kₘ(y) containing parameters is determined.

At step 2: m+2 approximate deviation points are selected from the domain of definition, and the m+2 approximate deviation points are substituted into a relational expression composed of the approximate function Kₘ(y) containing parameters and a deviation amplitude E, to obtain a m+2-dimensional system of linear equations Kₘ(yₖ)−T=(−1)^{k+1}E, where k=0,1,2 . . . m+1, the m is an integer greater than 0, and the Tis any natural number in the domain of definition.

At step 3: the system of linear equations Kₘ(yₖ)−T=(−1)^{k+1}E is solved to obtain a value of a parameter in the approximate function Kₘ(y) containing parameters.

At step 4: a target approximate function is determined based on the value of the parameter.

At step 5: the polynomial function P(y) is determined based on the target approximate function.

If the approximate function Kₘ(y) containing parameters is an even function, the Kₘ(y)=Σᵢ₌₀^{m}θ₂ᵢy²ⁱ⁺¹; and if the approximate function Kₘ(y) containing parameters is an odd function, the Kₘ(y)=Σᵢ₌₀^{m}θ₂ᵢ₊₁y²ⁱ⁺². The θ₂ᵢ, θ₂ᵢ₊₁ are parameters, and the i is an integer greater than or equal to 0. Here, the approximate function Kₘ(y) containing parameters being an even function is taken as an example.

The approximate function Kₘ(y) containing parameters has a domain of definition S=[−|λ_{A}|ₘₐₓ, −|λ_{A}|ₘᵢₙ]∪[|λ_{A}|ₘᵢₙ, |λ_{A}]ₘₐₓ], where |λ_{A}|ₘₐₓ is a maximum absolute value of eigenvalues of the first matrix A, and |λ_{A}|ₘᵢₙ is a minimum absolute value of eigenvalues of the first matrix A. The m+2 approximate deviation points have a size relationship: y₀<y₁< . . . <yₘ<yₘ₊₁, which may be an arithmetic progression or not and is not limited herein.

The m+2-dimensional system of linear equations Kₘ(yₖ)−T=(−1)^{k+1}E may be solved to obtain m+2 unknowns E, θ₂ᵢ, i=0,1,2 . . . m.

The relational expression composed of the approximate function Kₘ(y) containing parameters and the deviation amplitude E may be Kₘ(yₖ)−T=(−1)^{k+1}E or Kₘ(yₖ)−T=(−1)^{k}E, which lead to E having opposite signs.

Specifically, in terms of determining the target approximate function based on the value of the parameter, the method includes the following steps.

At step 1: the value of the parameter is substituted into the approximate function Kₘ(y) containing parameters to obtain an initial approximate function.

At step 2: an extreme point of an absolute value of a difference between the initial approximation function and the T is determined.

At step 3: if the extreme point and the m+2 approximation deviation points are equal within an accuracy requirement, the initial approximate function is determined as the target approximate function.

At step 4: if the extreme point and the m+2 approximation deviation points are not equal within the accuracy requirement, the extreme point is taken as a new point of the m+2 approximate deviation points, and the step of substituting the m+2 approximate deviation points into the relational expression composed of the approximate function Kₘ(y) containing parameters and the deviation amplitude E is performed to obtain the m+2-dimensional system of linear equations Kₘ(yₖ)−T=(−1)^{k+1}E.

The accuracy requirement may include, for example, the same three decimal places. If the extreme point and the corresponding approximate deviation point have the same three decimal places, it is determined that the two are equal within the accuracy requirement. Apparently, the accuracy requirement is not limited to three decimal places, and may include the first digit, two decimal places, five decimal places, seven decimal places, or any other value, which is not limited herein.

Specifically, in the aspect of determining the polynomial function P(y) based on the target approximate function, the method includes: determining, based on a relational expression P(y)=K(y)/f(y) of the target approximation function and the polynomial function P(y), the polynomial function P(y).

Specifically, in the aspect of constructing the operator P based on the polynomial P(A), the method includes: preparing an operator P corresponding to the polynomial P(A) through quantum signal processing (QSP).

The QSP ensures that a quantum operator mapped from a polynomial defined over a field of real numbers can be prepared if and only if the polynomial is an odd or even function (that is, the polynomial has pure odd or even orders).

In a specific embodiment of the present disclosure, solving the unknown x through the system of linear equations A″x=b″ constructed from the third matrix A″ and third vector b″ includes the following steps.

At step 1: an operator U̅ for the HHL algorithm is determined based on the third matrix A″.

At step 2: the quantum state |b′) corresponding to the third vector b″ and the operator U̅ are input to the HHL algorithm, to determine a target quantum state including a value of the unknown x.

At step 3: a solution result of the unknown x is determined based on the target quantum state.

Specifically, in the aspect of determining the operator U for the HHL algorithm based on the third matrix A″, the method includes the following steps.

At step 1: the operator U̅=e^{iA′t} for HHL is determined.

At step 2: the operator U̅=e^{iA′t} is expanded according to the Jacobi-Anger expansion to determine an exponential expansion of the operator U̅, where the exponential expansion of the operator U̅ is:

$${e}^{i γ t} = {J}_{0} ( t ) + 2 {\sum }_{k = 1}^{∞} {( - 1 )}^{κ} {J}_{2 k} ( t ) {T}_{2 k} ( γ ) + 2 i {\sum }_{k = 0}^{∞} {( - 1 )}^{k} {J}_{2 k + 1} ( t ) {T}_{2 k} ( γ ) ,$$

where Jₖ is a k^{th} order Bessel function of the first kind, and Tₖ is a k^{th} order Chebyshev polynomial of the first kind.

At step 3: the exponential expansion of the operator U̅ is saved in accuracy of a q^{th} order, where the exponential expansion of the operator U̅ in accuracy of the q^{th} order is:

$${e}^{i γ t} = {f}_{1} ( γ , t ) + {f}_{2} ( γ , t ) ,$$

where

$$\begin{matrix}{f}_{1} ( γ , t ) = {J}_{0} ( t ) + 2 {\sum }_{k = 1}^{q} {( - 1 )}^{k} {J}_{2 k} ( t ) {T}_{2 k} ( γ ) , \\ {f}_{2} ( γ , t ) = 2 i {\sum }_{k = 0}^{q} {( - 1 )}^{k} {J}_{2 k + 1} ( t ) {T}_{2 k} ( y ) , and \\ γ = P ( A ) A .\end{matrix}$$

At step 4: an operator f̅₁ corresponding to f₁(γ,t) and an operator f̅₂ corresponding to f₂(γ, t) are prepared through the QSP.

At step 5: the operator U̅ is constructed through linear combination of unitary operators (LCU), the operator f̅₁ and the operator f̅₂.

When k is a positive integer, Jₖ(−x)=(−1)^{k}Jₖ(x), Tₖ(−x)=(−1)^{k}Tₖ(x), and therefore f₁(γ,t) is an even function, and f₂(γ,t) is an odd function. Therefore, operators f̅₁, f̅₂ can also be prepared through QSP. After the operators f̅₁, f̅₂ are prepared, the operator U may be constructed through LCU, as shown in FIG. 6.

A success rate of constructing U̅ in this way is η, and after amplitude estimation and amplitude amplification, the success rate can be amplified to n=1. In the subsequent QPE process, 0(−log ϵ) controlled U̅ gates will appear, and a success rate of the whole process is

$$ζ = \frac{1}{{ϵ}^{δ}} ,$$

where δ=log η. Therefore, when η approaches 1, the whole algorithm process approaches 1.

Specifically, in the aspect of inputting the quantum state |b′) corresponding to the vector b′ and the operator U̅ to the HHL algorithm to determine the target quantum state including a value of the unknown x, the method includes the following steps.

At step 1: a quantum state |b′) is prepared.

At step 2: the initial quantum state is evolved to a target quantum state containing a value of the unknown x through quantum phase estimation (QPE) and controlled rotation operations, where a quantum logic gate required in the QPE is the U̅. Specifically, the HHL algorithm needs three registers, each containing at least one qubit. Before executing the HHL algorithm, the three registers need to be initialized. In other words, the qubits in the three registers are all initialized to |0 [symbol] . Then, the |0 [symbol] in the third register are converted into a quantum state |b [symbol] of the vector b in a general method. Then, a step 2023 of applying the operator P̅ to the quantum state |b [symbol] to obtain a quantum state |b′ [symbol] , where the quantum state |b′ [symbol] =Σᵢ₌₀ⁿ⁻¹βᵢ|uᵢ [symbol] , is performed.

In the HHL algorithm, the QPE specifically includes: sequentially acting on the second register through an H gate, acting on the second register and the third register through a controlled U gate, and acting on the second register through a FT^{†} gate, where the FT gate is a quantum logic gate corresponding to the Fourier transform. Through the QPE, the quantum state Σᵢ₌₀ⁿ⁻¹βᵢ|uᵢ [symbol] is converted into the quantum state |ψ₁ [symbol] =Σᵢ₌₀ⁿ⁻¹βᵢ| [symbol] |uᵢ [symbol] , where [symbol] is an estimated value of the eigenvalue λᵢ obtained by QPE.

The controlled operation specifically includes applying a controlled R gate to the first register and the second register, where the second register is a control bit and the first register is a controlled bit, and performing controlled rotation on the quantum state of the auxiliary bit through a sub-quantum state | [symbol] [symbol] of the quantum state |ψ₁ [symbol] =Σᵢ₌₀ⁿ⁻¹βᵢ| [symbol] |uᵢ [symbol] , to obtain a quantum state

$$\vert {ψ}_{2} 〉 = {\sum }_{i = 0}^{n - 1} {β}_{i} \vert 〉 \vert {u}_{i} 〉 ( \sqrt{1 - \frac{{C}^{2}}{{2}^{}}} \vert 0 〉 + \frac{C}{} \vert 1 〉 ) .$$

The first register is measured, and when the quantum state of the first register is |1 [symbol] , a quantum state

$$\vert {ψ}_{3} 〉 = {\sum }_{i = 0}^{n - 1} \frac{C {β}_{i}}{{\tilde{λ}}_{ι}} \vert {\tilde{λ}}_{ι} 〉 \vert {u}_{i} 〉 \vert 1 〉$$

is obtained.

The quantum state

$$\vert {ψ}_{3} 〉 = {\sum }_{i = 0}^{n - 1} \frac{C {β}_{i}}{{\tilde{λ}}_{ι}} \vert {\tilde{λ}}_{ι} 〉 \vert {u}_{i} 〉 \vert 1 〉$$

is evolved to a target quantum state

$$\vert {ψ}_{4} 〉 = {\sum }_{i = 0}^{n - 1} \frac{{β}_{i}}{{\tilde{λ}}_{ι}} \vert {u}_{i} 〉$$

containing a value of the unknown x through an inverse operation of QPE.

Specifically, a solution result of the unknown x is determined based on the target quantum state, that is, the unknown x takes a value

$$\frac{{β}_{i}}{{\tilde{λ}}_{ι}} \vert {u}_{i} 〉 .$$

After practical verification, an optimization multiple of the condition number κ_{A} of the matrix A achieved by the method for solving a system of linear equations including a polynomial preprocessor provided in the embodiments of the present disclosure is χ=

$$\frac{{κ}_{A}}{{κ}_{{A}^{′}}} ∼ l ,$$

which means that the optimization multiple of the condition number has a linear relationship with the order of the input polynomial Pₘ. The overall solution complexity is O(ls²κ_{A′}² log N), which is optimized by

$$\overline{ω} = \frac{{{κ}_{A}}^{2}}{l {{κ}_{{A}^{′}}}^{2}} ∼ l$$

compared with the solution complexity O(s²κ_{A}² log N) of HHL. It can be seen that the degree of optimization increases linearly with l. When l→O(κ_{A}), κ_{A′}→1, the solution complexity of the method for solving a system of linear equations including a polynomial preprocessor provided in the embodiments of the present disclosure is reduced to the minimum O(s²κ_{A} log N).

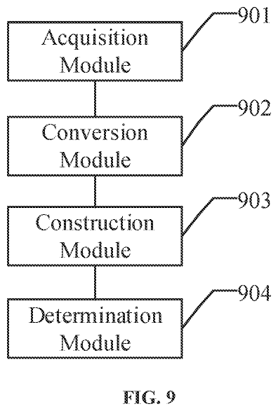

FIG. 9 is a schematic structural diagram of an apparatus for solving a system of nonlinear equations on the basis of a quantum circuit according to an embodiment. As shown in FIG. 9, the apparatus includes:
an acquisition module 901 configured to acquire a target system of nonlinear equations to be solved;
a conversion module 902 configured to convert the target system of nonlinear equations to obtain a target system of linear equations;
a construction module 903 configured to construct a quantum circuit corresponding to a quantum linear solver used for solving the target system of linear equations;
a determination module 904 configured to perform, based on the quantum circuit corresponding to the quantum linear solver, quantum state evolution and measurement on the target system of linear equations, to solve the target system of linear equations, and determine, based on an obtained solution of the target system of linear equations, a solution of the target system of nonlinear equations to be solved. The specific details may be referred to the above description in conjunction with FIG. 2, and will not be repeated here.

An embodiment of the present disclosure further provides a storage medium having a computer program stored thereon, where the computer program is configured to, when executed, cause the method for solving a system of nonlinear equations on the basis of a quantum circuit described above with reference to FIG. 2 to be implemented.

In addition, an embodiment of the present disclosure further provides an electronic device, including a memory and a processor, where the memory has a computer program stored thereon, and the processor is configured to execute the computer program to implement the method for solving a system of nonlinear equations on the basis of a quantum circuit described above with reference to FIG. 2.

As used in the description and the claims, the term “if” may be interpreted contextually as “when . . . ” or “once” or “in response to determining” or “in response to detecting.” Similarly, the phrase “if it is determined” or “if [the described condition or event] is detected” may be interpreted contextually as meaning “upon determining” or “in response to determining” or “upon detecting [the described condition or event]” or “in response to detecting [the described condition or event].”

Although the implementations of the present disclosure have been described above, they are merely the embodiments used for facilitating understanding the present disclosure, and are not intended to limit the scope and application scenarios of the present disclosure. Any skilled person in the art of the present disclosure can make any modification and variation in implementation forms and details without departing from the spirit and scope revealed in the present disclosure, but the patent protection scope of the present disclosure shall still be subject to the scope defined in the attached claims.

1. A method for solving a system of nonlinear equations on the basis of a quantum circuit, the method comprising:
acquiring a target system of nonlinear equations to be solved;
converting the target system of nonlinear equations to be solved to obtain a target system of linear equations;
constructing a quantum circuit corresponding to a quantum linear solver used for solving the target system of linear equations;
performing, based on the quantum circuit corresponding to the quantum linear solver, quantum state evolution and measurement on the target system of linear equations, to solve the target system of linear equations; and
determining, based on an obtained solution of the target system of linear equations, a solution of the target system of nonlinear equations to be solved.

2-13. (canceled)

14. The method of claim 1, further comprising:
embedding the target system of linear equations into a linear system, wherein the linear system includes a first matrix A and a first vector b, and the linear system includes a condition number κ_{A};
calculating a polynomial p(A) of the first matrix A in the linear system; and
pre-processing the linear system according to the polynomial p(A) to obtain a second matrix A′ and a second vector b′.

15. The method of claim 14, wherein the pre-processing of the linear system includes:
the second matrix A′=p(A)A, and the second vector b′=p(A)b.

16. The method of claim 14, wherein the pre-processing of the linear system includes:
constructing an operator P̅ based on the polynomial P(A), and applying the operator P̅ to the quantum state |b) to obtain a quantum state |b′ [symbol] , wherein the quantum state |b′ [symbol] is a quantum state corresponding to the second vector b′; and
multiplying the polynomial P(A) by the first matrix A to obtain the second matrix A′.

17. The method of claim 16, wherein the constructing of the operator P̅ based on the polynomial P(A) includes:
preparing the operator P̅ corresponding to the polynomial P(A) through quantum signal processing (QSP).

18. The method of claim 14, wherein the constructing of the quantum circuit further includes constructing a quantum circuit corresponding to a Harrow-Hassidim-Lloyd algorithm (HHL) algorithm based on the second matrix A′ and the second vector b′; and
the performing of the quantum state evolution and measurement further includes performing quantum state evolution and measurement operations by the quantum circuit corresponding to the HHL algorithm to solve the target system of linear equations.

19. The method of claim 18, wherein the constructing of the quantum circuit includes:
obtaining several qubits including an auxiliary qubit, a first qubit, and a second qubit, wherein initial states of the auxiliary qubit and the first qubit are set to |0 [symbol] , an initial state of the second qubit is set to |b′ [symbol] =Σᵢ₌₁^{N}bᵢ′|i [symbol] , the bᵢ′ is an i^{th} element of the second vector b′, and the N is a dimension number of the second vector;
determining a unitary matrix U̅ corresponding to the second matrix A′;
constructing a first sub-quantum circuit module for phase estimation, which is used to decompose the |b′ [symbol] into |b′ [symbol] =Σⱼ₌₁^{N}βⱼ|μⱼ [symbol] in eigenspace of the second matrix A′, and transforming the initial state |0 [symbol] |b′ [symbol] of the first qubit and the second qubit into Σⱼ₌₁^{N}βⱼ|λⱼ [symbol] |μⱼ [symbol] , wherein the |μⱼ [symbol] is an eigenvector of the second matrix A′, the λⱼ is an eigenvalue of the second matrix A′, and the βⱼ is an eigenvector amplitude of the second matrix A′;
constructing a second sub-quantum circuit module for performing a controlled rotation operation, which uses |λⱼ [symbol] as a control bit to rotate the auxiliary qubit to obtain
$${\sum }_{j = 1}^{N} {β}_{j} \vert {λ}_{j} 〉 \vert {µ}_{j} 〉 ( \sqrt{1 - \frac{{C}^{2}}{{{λ}_{j}}^{2}}} \vert 0 〉 + \frac{C}{{λ}_{j}} \vert 1 〉 ) ,$$
wherein the C is a normalization constant;
constructing a third sub-quantum circuit module for performing inverse phase estimation, which is used to reset |λⱼ [symbol] to |0 [symbol] ;
constructing a measurement operation module for the auxiliary qubit, so that when the measured quantum state of the auxiliary qubit is |1 [symbol] :
$$\vert {x}^{′} 〉 = \frac{1}{\sqrt{{\sum }_{j = 1}^{N} {( C {{λ}_{j}}^{- 1} {β}_{j} )}^{2}}} {\sum }_{j = 1}^{N} C {{λ}_{j}}^{- 1} {β}_{j} \vert {µ}_{j} 〉 ,$$
and the |x′ [symbol] ∝|x [symbol] ; and
sequentially forming the first sub-quantum circuit module, the second sub-quantum circuit module, the third sub-quantum circuit module, and the quantum measurement operation module into the quantum circuit corresponding to the HHL algorithm.

20. The method of claim 18, wherein the performing of the quantum state evolution and measurement operations includes:
inputting the initial quantum state |b′ [symbol] and the unitary matrix U̅ to the quantum circuit corresponding to the HHL algorithm, and performing quantum state evolution and measurement operations by the quantum circuit corresponding to the HHL algorithm to obtain a final quantum state of the evolved quantum circuit; and
solving the target system of linear equations based on the final quantum state.

21. The method of claim 18, wherein the performing of quantum state evolution and measurement operations includes:
in response to the condition number κ_{A} greater than a preset threshold, constructing a third matrix A″ and a third vector b″ based on the linear system;
determining an operator U̅ for the HHL algorithm based on the third matrix A″;
inputting the quantum state |b′) corresponding to the third vector b″ and the operator U̅ to the HHL algorithm, to determine a target quantum state including a value of the unknown x; and
determining a solution result of the unknown x based on the target quantum state, to solve the target system of linear equations.

22. The method of claim 21, wherein the determining of the operator U̅ for the HHL algorithm based on the third matrix A″ includes:
determining the operator U̅=e^{iA′t} for the HHL algorithm;
expanding the operator U̅=e^{iA′t} according to the Jacobi-Anger expansion to determine an exponential expansion of the operator U̅, wherein the exponential expansion of the operator U̅ is:
$${e}^{i γ t} = {J}_{0} ( t ) + 2 {\sum }_{k = 1}^{∞} {( - 1 )}^{k} {J}_{2 k} ( t ) {T}_{2 k} ( γ ) + 2 i {\sum }_{k = 0}^{∞} {( - 1 )}^{k} {J}_{2 k + 1} ( t ) {T}_{2 k} ( γ ) ,$$
where Jₖ is a k^{th} order Bessel function of the first kind, and Tₖ is a k^{th} order Chebyshev polynomial of the first kind;
saving the exponential expansion of the operator U̅ in accuracy of a q^{th} order, wherein the exponential expansion of the operator U̅ in accuracy of the q^{th} order is:
$$\begin{matrix}{e}^{i γ t} = {f}_{1} ( γ , t ) + {f}_{2} ( γ , t ) , \\ where {f}_{1} ( γ , t ) = {J}_{0} ( t ) + 2 {\sum }_{k = 1}^{q} {( - 1 )}^{k} {J}_{2 k} ( t ) {T}_{2 k} ( γ ) , \\ {f}_{2} ( γ , t ) = - 2 i {\sum }_{k = 0}^{q} {( - 1 )}^{k} {J}_{2 k + 1} ( t ) {T}_{2 k} ( γ ) , and \\ γ = P ( A ) A ;\end{matrix}$$
preparing an operator f̅₁ corresponding to f₁(γ, t) and an operator f̅₂ corresponding to f₂(γ, t) through the QSP; and
constructing the operator U̅ through linear combination of unitary operators (LCU), the operator f̅₁ and the operator f̅₂.

23. The method of claim 14, wherein the calculating of the polynomial p(A) of the first matrix A in the linear system includes:
constructing a function ƒₘ(x) and a preset interval S for solving the polynomial, wherein the function ƒₘ(x) satisfies fₘ(x)=pₘ(x)x, and fₘ(x₂)+(−1)ⁱE=1, the m is a polynomial order, the i=0,1,2, . . . , m+1, the S∈[1/κ_{A}, 1], the E is a deviation amplitude, and the κ_{A} is a condition number;
selecting m+1 points in the preset interval, and acquiring a solution of a system of intermediate linear equations fₘ(x₂)+(−1)ⁱE=1, wherein the m+1 points are respectively x₁, x₂, . . . , xₘ₊₁, and satisfy x₁=1/κ, xₘ₊₁=1;
substituting the acquired solution of the system of intermediate linear equations into fₘ(x) to obtain a set N′ of points corresponding to local maximum values of |1−fₘ(x)|;
judging whether an absolute value of fₘ(x)−1 is the same for any x∈N′, and whether a sign of fₘ(x)−1 changes between plug and minus alternately as x increases; and
determining, according to a judgment result, the polynomial p(A) of the first matrix A.

24. The method of claim 23, wherein the determining of the polynomial p(A) of the first matrix A includes:
in response to that the sign of fₘ(x)−1 changes between plug and minus alternately, determining a current fₘ(x) as an optimal polynomial and as the polynomial p(A) of the first matrix A; or
in response to that the sign of fₘ(x)−1 does not change between plug and minus alternately, replacing elements in x₁, x₂, . . . , xₘ₊₁ with elements in the set N′ according to a rule including: replacing x₂, . . . , xₘ with elements in the set N′ while x₁, xₘ₊₁ remain unchanged, and then returning to perform the step of acquiring a solution of the system of intermediate linear equations fₘ(xᵢ)+(−1)ⁱE=1, until an optimal fₘ(x) satisfying the judgment condition is obtained, so as to determine the polynomial p(A) of the first matrix A.

25. The method of claim 23, further comprising, before the calculating of the polynomial p(A) of the first matrix A in the linear system:
acquiring an approximate function Kₘ(y) containing parameters, and determining a domain of definition of the approximate function Kₘ(y) containing parameters;
selecting m+2 approximate deviation points from the domain of definition, and substituting the m+2 approximate deviation points into a relational expression composed of the approximate function Kₘ(y) containing parameters and a deviation amplitude E, to obtain a m+2-dimensional system of intermediate linear equations Kₘ(yₖ)−T=(−1)^{k+1}E, where k=0,1,2 . . . m+1, the m is an integer greater than 0, and the Tis any natural number in the domain of definition;
solving the system of intermediate linear equations Kₘ(yₖ)−T=(−1)^{k+1}E, to obtain a value of a parameter in the approximate function Kₘ(y) containing parameters;
determining a target approximate function based on the value of the parameter; and
determining, based on the target approximate function, a polynomial function P(y) for determining the polynomial P(A).

26. The method of claim 25, wherein the determining of the target approximate function based on the value of the parameter includes:
substituting the value of the parameter into the approximate function Kₘ(y) containing parameters to obtain an initial approximate function;
determining an extreme point of an absolute value of a difference between the initial approximation function and the T;
if the extreme point and the m+2 approximation deviation points are equal within an accuracy requirement, determining the initial approximate function as the target approximate function; or
if the extreme point and the m+2 approximation deviation points are not equal within the accuracy requirement, taking the extreme point as a new point of the m+2 approximate deviation points, and performing the step of substituting the m+2 approximate deviation points into the relational expression composed of the approximate function Kₘ(y) containing parameters and the deviation amplitude E to obtain the m+2-dimensional system of intermediate linear equations Kₘ(γₖ)−T=(−1)^{k+1}E.

27. The method of claim 26, wherein the determining of the polynomial function P(y) includes:
determining, based on a relational expression P(y)=K(y)/f(y) of the target approximation function and the polynomial function P(y), the polynomial function P(y), wherein the f(y)=y.

28. The method of claim 22, wherein, if the approximate function Kₘ(y) containing parameters is an even function, the Kₘ(y)=Σᵢ₌₀^{m}θ₂ᵢy²ⁱ⁺¹; and if the approximate function Kₘ(y) containing parameters is an odd function, the Kₘ(y)=Σᵢ₌₀^{m}θ₂ᵢ₊₁y²ⁱ⁺²; wherein the θ₂ᵢ, θ₂ᵢ₊₁ are parameters, and the i is an integer greater than or equal to 0.

29. (canceled)

30. A non-transitory storage medium storing a computer program configured to, when executed, cause a method for solving a system of nonlinear equations on the basis of a quantum circuit to be implemented,
the method comprising:
acquiring a target system of nonlinear equations to be solved;
converting the target system of nonlinear equations to be solved to obtain a target system of linear equations;
constructing a quantum circuit corresponding to a quantum linear solver used for solving the target system of linear equations;
performing based on the quantum circuit corresponding to the quantum linear solver, quantum state evolution and measurement on the target system of linear equations, to solve the target system of linear equations; and
determining, based on an obtained solution of the target system of linear equations, a solution of the target system of nonlinear equations to be solved.

31. An electronic device; comprising:
a memory having a computer program stored thereon; and
a processor configured to execute the computer program to implement a method for solving a system of nonlinear equations on the basis of a quantum circuit, the method comprising:
acquiring a target system of nonlinear equations to be solved;
converting the target system of nonlinear equations to be solved to obtain a target system of linear equations;
constructing a quantum circuit corresponding to a quantum linear solver used for solving the target system of linear equations;
performing, based on the quantum circuit corresponding to the quantum linear solver, quantum state evolution and measurement on the target system of linear equations, to solve the target system of linear equations; and
determining, based on an obtained solution of the target system of linear equations, a solution of the target system of nonlinear equations to be solved.

32. The non-transitory storage medium of claim 30, wherein the method further comprises:
embedding the target system of linear equations into a linear system, wherein the linear system includes a first matrix A and a first vector b, and the linear system includes a condition number κ_{A};
calculating a polynomial p(A) of the first matrix A in the linear system; and
pre-processing the linear system according to the polynomial p(A) to obtain a second matrix A′ and a second vector b′.

33. The electronic device of claim 31, wherein the method further comprises:
embedding the target system of linear equations into a linear system, wherein the linear system includes a first matrix A and a first vector b, and the linear system includes a condition number κ_{A};
calculating a polynomial p(A) of the first matrix A in the linear system; and
pre-processing the linear system according to the polynomial p(A) to obtain a second matrix A′ and a second vector b′.
